(19) United States
(12) Patent Application Publication
(10) Pub. No.: US 2009/0012887 A1
(43) Pub. Date: Jan. 8, 2009

(54) Method And System For Provision Of Personalized Service

(75) Inventors: Zippora Taub, Maccabim - Reut (IL); David Ron, Ganey Tikva (IL)

Correspondence Address: OLIFF & BERRIDGE, PLC, P.O. BOX 320850, ALEXANDRIA, VA, 22320-4850, US

(73) Assignee: T.K.T Technologies Ltd., Maccabim-Reut (IL)

(21) Appl. No.: 12/224,609

(22) PCT Filed: Mar. 1, 2007
(86) PCT No.: PCT/IL2007/000267

§ 371 Date: Sep. 2, 2008

Related U.S. Application Data
(60) Provisional application No. 60/777,567, filed on Mar. 1, 2006.

(51) Int. Cl. G06Q 99/00; G06Q 30/00

(52) U.S. Cl. 705/34; 705/1

(57) ABSTRACT

Systems and methods for servicing a user seeking a service over a computer network. In one embodiment the user visits a website of an administrative processing system which performs administrative processing for a plurality of service providers, including service provider(s) which will provide the service(s) to the user. In one embodiment, the administrative processing includes an interactive chat-like interview with the user. In one embodiment the administrative processing system is paid by the user and the payment is shared with the provider(s) who serviced the user.

### CROSS REFERENCE TO RELATED APPLICATIONS

This application claims the benefit of US Provisional Application No. 60/777,567 filed on Mar. 1, 2006 which is hereby incorporated by reference herein.

### FIELD OF THE INVENTION

This invention relates to methods and systems for providing a person with a service, for example including advice.

### BACKGROUND OF THE INVENTION

When a service provider provides a service to a customer, there are administrative tasks which are typically performed. The administrative tasks may include for example, gathering data from the customer, organizing the data (for example in a file or database), analyzing the data, etc.

These administrative tasks consume resources (for example time, manpower or computer power, money, etc) but the fee charged to the customer typically does not compensate for the consumed resources. Often, the service provider purposely does not charge or charges little for the administrative tasks in order to not cause a customer (who often may be shopping around) to look elsewhere for the service.

For a customer who is shopping around, the administrative tasks may in some cases be especially burdensome and repetitive. The customer is in some cases required to provide the same information repeatedly to each contacted service provider, even though the customer has not yet selected which service provider will provide the service. For the service providers which are not selected, the administrative tasks do not even lead to relationship with the customer and therefore the non-selected service providers may feel that the resources consumed in performing the administrative tasks were wasted. Some service providers may therefore postpone or neglect performing the administrative tasks due to the knowledge that customers may be shopping around, and the neglect or postponement may sometimes lead those service providers to provide an inferior service.

In some cases, administrative tasks can not be completed quickly by service providers, for example because the customer does not know the required information off-hand. There is typically little incentive for the service provider to ensure that the tasks are eventually completed due to the consumed resources, and little incentive for the customer to ensure that the administrative tasks are eventually completed because often the customer does not appreciate the contributive value of the administrative tasks to quality service.

In some cases the gathering of the information is standardized and therefore some of the questions asked to all customers may not be relevant to a particular customer. The customer may resent spending energy and time answering questions which are not relevant to him.

### SUMMARY OF THE INVENTION

According to the present invention, there is provided a method of servicing a user seeking a service over a computer network, comprising: (i) receiving a user-related input and defining a type of service requested by the user; (ii) automatically presenting the user with a plurality of questions relating to the service and preparing a personalized service profile based at least partly on answers of the user to the questions; (iii)electronically forwarding the personalized service profile to a service provider to generate a service output based at least partly on the personalized service profile; and (iv) providing the service output to the user.

According to the present invention, there is also provided a method of servicing a user seeking a service over a computer network, comprising: (i) a user logging onto a service provider web page; (ii) the user being routed to a system server; (iii) the system server identifying the type of service requested by the user; (iv) the system server posing service-related questions and receiving answers from the user; (v) the system server generating a personalized service profile based at least partly on the answers; (vi) the system server generating a payment request sometime during the method and monitoring payment by the user; (vii) if the user has paid, transmitting the personalized service profile to the service provider; and (viii) transferring a service output to the user by the system server or directly by the service provider.

According to the present invention, there is further provided a method of servicing a user seeking a service over a computer network, comprising: (i) a user logging onto a system server; (ii) the system server the type of service requested by the user; (iii) the system server posing service-related questions and receiving answers from the user; (iv) the system server generating a personalized service profile based at least partly on the answers; (v) the system server generating a payment request sometime during the method and monitoring payment by the user; (vi) if the user has paid, transmitting the personalized service profile to the service provider; and (vii) transferring a service output to the user by the system server or directly by the service provider.

According to the present invention, there is yet further provided a system for servicing a user seeking a service over a computer network, comprising: a user communications manager configured to provide a plurality of questions to a web browser of a user who is interested in receiving a service from any of a plurality of service providers; a job definer configured to prepare a personalized service profile based at least partly on answers of the user to the questions; and a service provider communications manager configured to forward the personalized service profile to a service provider for generating a service output based at least partly on the personalized service profile.

According to the present invention, there is provided a system for servicing a user seeking a service over a computer network, comprising: a user communications manager configured to identify the type of service requested by a user, and configured to pose service-related questions to the user; a job definer configured to generate a personalized service profile based at least partly on answers of the user to the questions; a payment processor configured to generate a payment request for the user and monitor payment by the user; and a service provider communications manager configured, if the user has paid, to forward the personalized service profile to a service provider; wherein a service output is transferred to the user by the user communications manager or directly by the service provider.

According to the present invention, there is also provided a system for servicing a user seeking a service over a computer network, comprising: a user communications manager configured to identify the type of service requested by a user who has logged on a web site of a service provider and been routed to the user communications manager, and configured to pose service-related questions to the user; a job definer configured to generate a personalized service profile based at least partly on answers of the user to the questions; a payment processor configured to generate a payment request for the user and monitor payment by the user; and a service provider communications manager configured, if the user has paid, to forward the personalized service profile to a service provider; wherein a service output is transferred to the user by the user communications manager or directly by the service provider.

According to the present invention there is further provided a network for providing services to users, comprising: a plurality of users; a plurality of service providers configured to provide services; and an administrative processing system configured to administratively process any of the plurality of users interested in receiving services from any of the plurality of service providers, including being configured to pose questions to users who visit a website of the system, to prepare personalized service profiles based at least partly on answers to posed questions, and to forward the developed service profiles to service providers.

According to the present invention, there is yet further provided a program storage device readable by machine, tangibly embodying a program of instructions executable by the machine to perform method steps of servicing a user seeking a service over a computer network, comprising: receiving a user-related input and defining a type of service requested by the user; automatically presenting the user with a plurality of questions relating to the service and preparing a personalized service profile based at least partly on answers of the user to the questions; electronically forwarding the personalized service profile to a service provider to generate a service output based at least partly on the personalized service profile; and providing the service output to the user.

According to the present invention, there is provided a computer program product comprising a computer useable medium having computer readable program code embodied therein of servicing a user seeking a service over a computer network, the computer program product comprising: computer readable program code for causing the computer to receive a user-related input and define a type of service requested by the user; computer readable program code for causing the computer to automatically present the user with a plurality of questions relating to the service and prepare at least one personalized service profile based at least partly on answers of the user to the questions; computer readable program code for causing the computer to electronically forward the personalized service profile to a service provider to generate a service output based at least partly on the personalized service profile; and computer readable program code for causing the computer to provide the service output to the user.

According to the present invention, there is also provided a program storage device readable by machine, tangibly embodying a program of instructions executable by the machine to perform method steps of servicing a user seeking a service over a computer network, comprising: identifying the type of service requested by a user who has logged onto a service provider web page and been redirected; posing service-related questions and receiving answers from the user; generating a personalized service profile based at least partly on the answers; generating a payment request and monitoring payment by the user; if the user has paid, transmitting the personalized service profile to the service provider; and transferring a service output to the user.

According to the present invention, there is further provided a computer program product comprising a computer useable medium having computer readable program code embodied therein of servicing a user seeking a service over a computer network, the computer program product comprising: computer readable program code for causing the computer to identify the type of service requested by a user who has logged onto a service provider web page and been redirected; computer readable program code for causing the computer to pose service-related questions and receive answers from the user; computer readable program code for causing the computer to generate a personalized service profile based at least partly on the answers; computer readable program code for causing the computer to generate a payment request and monitor payment by the user; computer readable program code for causing the computer, if the user has paid, to transmit the personalized service profile to the service provider; and computer readable program code for causing the computer to transfer a service output to the user.

According to the present invention there is yet further provided a program storage device readable by machine, tangibly embodying a program of instructions executable by the machine to perform method steps of servicing a user seeking a service over a computer network, comprising: identifying the type of service requested by a user; posing service-related questions and receiving answers from the user; generating a personalized service profile based at least partly on the answers; generating a payment request and monitoring payment by the user; if the user has paid, transmitting the personalized service profile to the service provider; and transferring a service output to the user.

According to the present invention, there is still further provided a computer program product comprising a computer useable medium having computer readable program code embodied therein of servicing a user seeking a service over a computer network, the computer program product comprising: computer readable program code lo for causing the computer to identify the type of service requested by a user; computer readable program code for causing the computer to pose service-related questions and receive answers from the user; computer readable program code for causing the computer to generate a personalized service profile based at least partly on the answers; computer readable program code for causing the computer to generate a payment request and monitor payment by the user; computer readable program code for causing the computer, if the user has paid, to transmit the personalized service profile to the service provider; and computer readable program code for causing the computer to transfer a service output to the user.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a simplified schematic flowchart illustrating a method of providing a user with a service, in accordance with an embodiment of the present invention;

FIG. 2 is a simplified schematic block diagram of a configuration for providing a user with a service, in accordance with an embodiment of the present invention;

FIG. 3 is a simplified schematic flowchart illustrating an interactive method for receiving user inputs in stage 115 of FIG. 1, in accordance with an embodiment of the present invention;

FIG. 4 is a simplified schematic flowchart illustrating an embodiment of stages 115-120 of FIG. 1 with respect to user attributes;

FIG. 5 is a simplified schematic flowchart illustrating an embodiment of stages 125-130 of FIG. 1;

FIG. 6 is an illustration of a personalized service profile, in accordance with an embodiment of the present invention;

FIG. 7 is an illustration of a personalized service profile, in accordance with an embodiment of the present invention;

FIG. 8 is an illustration of a list of service requests, in accordance with an embodiment of the present invention;

FIG. 9 is a simplified schematic flowchart illustrating a method of interactive analysis, in accordance with an embodiment of the present invention;

FIG. 10 is a simplified schematic flowchart illustrating a method of providing a financial transaction service involving at least two users, in accordance with an embodiment of the present invention.;

FIG. 11 is an illustration of a graphical user interface for conducting an interactive interview, in accordance with an embodiment of the present invention;

FIG. 12 is an illustration of another graphical user interface for conducting an interactive interview, in accordance with an embodiment of the present invention;

FIG. 13 is an illustration of another graphical user interface for conducting an interactive interview, in accordance with an embodiment of the present invention;

FIG. 14 is an illustration of another graphical user interface for conducting an interactive interview, in accordance with an embodiment of the present invention;

FIG. 15 is an illustration of another graphical user interface for conducting an interactive interview, in accordance with an embodiment of the present invention;

FIG. 16 is an illustration of another graphical user interface for conducting an interactive interview, in accordance with an embodiment of the present invention;

FIG. 17 is an illustration of another graphical user interface for conducting an interactive interview, in accordance with an embodiment of the present invention;

FIG. 18 is an illustration of another graphical user interface for conducting an interactive interview, in accordance with an embodiment of the present invention;

FIG. 19 is an illustration of another graphical user interface for conducting an interactive interview, in accordance with an embodiment of the present invention;

FIG. 20 is an illustration of another graphical user interface for conducting an interactive interview, in accordance with an embodiment of the present invention;

FIG. 21 is an illustration of another graphical user interface for conducting an interactive interview, in accordance with an embodiment of the present invention;

FIG. 22 is an illustration of another graphical user interface for conducting an interactive interview, in accordance with an embodiment of the present invention;

FIG. 23 is an illustration of another graphical user interface for conducting an interactive interview, in accordance with an embodiment of the present invention;

FIG. 24 is an illustration of another graphical user interface for conducting an interactive interview, in accordance with an embodiment of the present invention;

FIG. 25 is an illustration of another graphical user interface for conducting an interactive interview, in accordance with an embodiment of the present invention;

FIG. 26 is an illustration of another graphical user interface for conducting an interactive interview, in accordance with an embodiment of the present invention;

FIG. 27 is an illustration of another graphical user interface for conducting an interactive interview, in accordance with an embodiment of the present invention;

FIG. 28 is an illustration of another graphical user interface for conducting an interactive interview, in accordance with an embodiment of the present invention;

FIG. 29 is an illustration of another graphical user interface for conducting an interactive interview, in accordance with an embodiment of the present invention; and

FIG. 30 is an illustration of another graphical user interface for conducting an interactive interview, in accordance with an embodiment of the present invention; and

FIG. 31 is an illustration of another graphical user interface for conducting an interactive interview, in accordance with an embodiment of the present invention.

### DETAILED DESCRIPTION OF EXEMPLARY EMBODIMENTS

Embodiments of the invention are directed to methods, systems and products for providing a user with a service for example including advice, at least partly over at least one communication system. Advice should be understood to include inter-alia information permitting the user to plan an activity.

In some embodiments, the communication system includes the Internet and an interactive process is conducted with the user via a website. In some cases, the advice relates to financial, budget, architectural, legal, insurance, personal, psychological, medical, and/or any other matters. For example, in one embodiment the service provider may be a “guru”.

As used herein, the phrase “for example,” “such as” and variants thereof describing exemplary implementations of the present invention are exemplary in nature and not limiting.

Reference in the specification to “one embodiment”, “an embodiment”, “some embodiments”, “another embodiment”, “other embodiments” or variations thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments” or variations thereof do not necessarily refer to the same embodiment(s).

The present invention is primarily disclosed as a method and it will be understood by a person of ordinary skill in the art that an apparatus such as a conventional data processor incorporated with a database, software and other appropriate components may be programmed or otherwise designed to facilitate the practice of the method of the invention.

Unless specifically stated otherwise, as apparent from the following discussions, it is appreciated that throughout the specification discussions, utilizing terms such as, “receiving”, “presenting”, “collecting”, “generating”, “transmitting”, “providing”, “defining”, “checking”, “posing”, “determining”, “processing”, “asking”, “sharing”, “preparing”, “forwarding”, “identifying” or the like, refer to the action and/or processes of any combination of software, hardware and/or firmware. For example, in one embodiment a computer, processor or similar electronic computing system may manipulate and/or transform data represented as physical, such as electronic, quantities within the computing system's registers and/or memories into other data, similarly represented as physical quantities within the computing system's memories, registers or other such information storage, transmission or display devices.

Embodiments of the present invention may use terms such as, processor, device, system, computer, apparatus, system, sub-system, module, component etc, (in single or plural form) for performing the operations herein. These terms, as appropriate, refer to any combination of software, hardware and/or firmware configured to perform the operations as defined and explained herein. The module(s) (or counterpart terms specified above) may be specially constructed for the desired purposes, or it may comprise a general purpose computer selectively activated or reconfigured by a program stored in the computer. Such a program may be stored in a readable storage medium, such as, but not limited to, any type of disk including optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, any other type of media suitable for storing electronic instructions that are capable of being conveyed, for example via a computer system bus.

The method(s)/processe(s)/module(s) (or counterpart terms for example as specified above) and screen(s) presented herein are not inherently related to any particular system or other apparatus, unless specifically stated otherwise. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

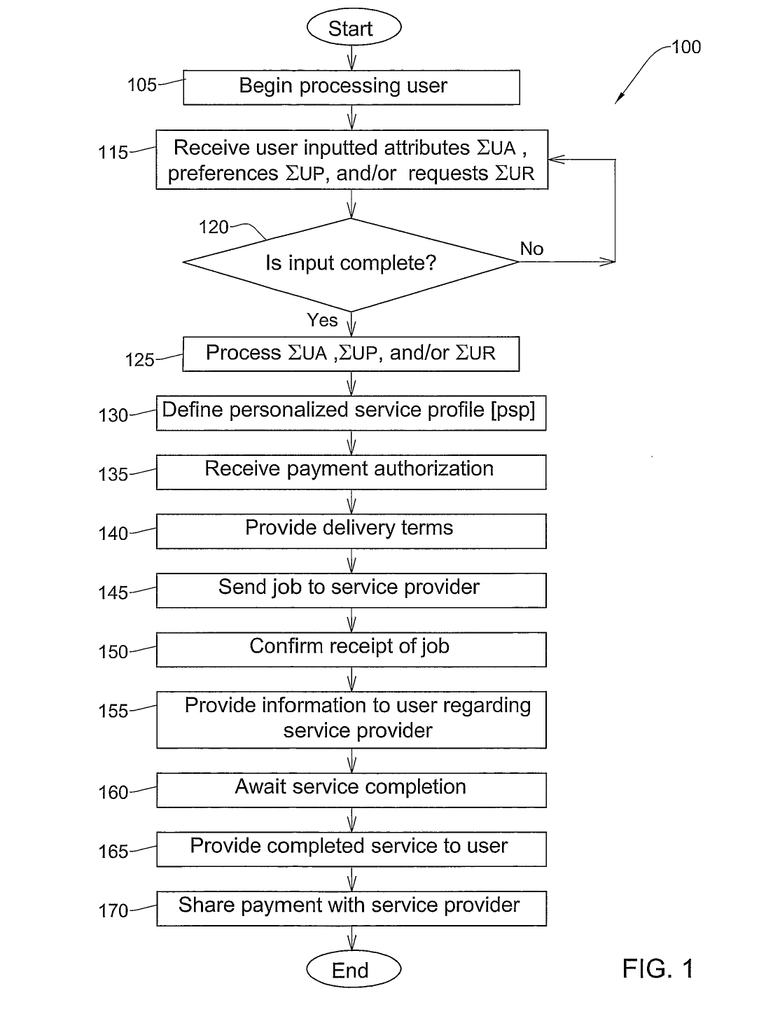

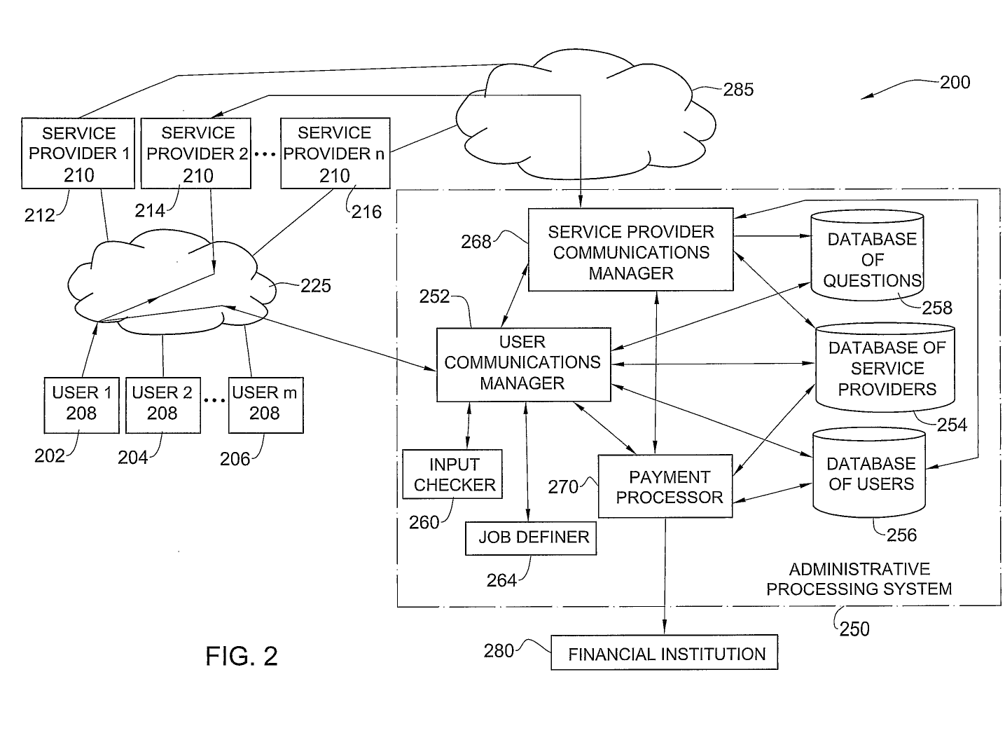

Reference is now made to FIG. 1, which is a simplified schematic flowchart illustrating a method 100 of providing a user with a service, for example including advice, in accordance with an embodiment of the present invention. Method 100 is performed by an administrative processing system (also termed herein below “system server”). The administrative processing system may be for example the administrative processing system 250 of FIG. 2 described further below.

In stage 105, the administrative processing of the user begins when a user reaches the administrative processing system. For example, assuming the user reaches the administrative processing system via the World Wide Web, the user may independently reach the web site of the administrative processing system or may be directed to the web site of the administrative processing system by a service provider, for example via a link on the web site of the service provider. As another example, the service provider may provide the user with the web address of the administrative processing system without providing a link.

In stage 115, the administrative processing system receives user inputs. These inputs typically although not necessarily include a) at least one user attribute (ΣUA); (b) at least one user preference (ΣUP) and c) at least one request for service (ΣUR) (for example at least one requested advice or piece of required advice). The inputs at least allow the administrative processing system to identify the type(s) of service(s) requested. Alternatively, the administrative processing system may identify the requested service(s) based on which service provider directed the user to the administrative processing system or based on an indication(s) of the requested service(s) which may have been transferred from the service provider to the user and therefrom to the processing system.

In one embodiment, at least one of the user attributes is selected from, but not limited to, an age attribute, a gender attribute, a geographical attribute, a socio-economic attribute, an ethnic attribute, a religious attribute, a personal dimension attribute, a personal ability attribute, a class attribute, an educational attribute, a political attribute and a national attribute.

In one embodiment, at least one of the user requests for services is selected from, but not limited to, mortgage advice, investment advice, savings advice, pension advice, personal advice, insurance related advice, architectural advice, legal advice, medical advice, guru advice, or life coaching advice.

In one embodiment, at least one of the user preferences is selected from, but not limited to, a preferred location, a preferred budget, a preferred risk level, a preferred payback time, a preferred return on investment, a preferred product quality and a preferred product quantity; a preferred interest rate, a preferred professional contact and a preferred company contact.

For example, if a requested service relates to advice on mortgages, the preferences may be, for example:

i) choosing a building society or bank;

ii) choosing which building society or bank is preferred with respect to a) name of the bank or building society, b) size of the bank or building society; c) geographical location thereof; d) Internet services provided by the bank or building society;

iii) choosing the general type of mortgage required, if known, such as simple mortgage, mortgage with endowment policy and mortgage with life insurance policy. In some cases the user will not know how to input the definitions in iii). The user may then be guided on how to choose a first option. Hereinbelow for simplicity of description the single form of service, type of service, or of similar terms is used to include both embodiments where there is one service and embodiments where there is a plurality of services requested by a user. Hereinbelow for simplicity of description the plural form of attributes and/or the plural form of preferences is used to include embodiments relating to one or more attributes and/or one or more preferences.

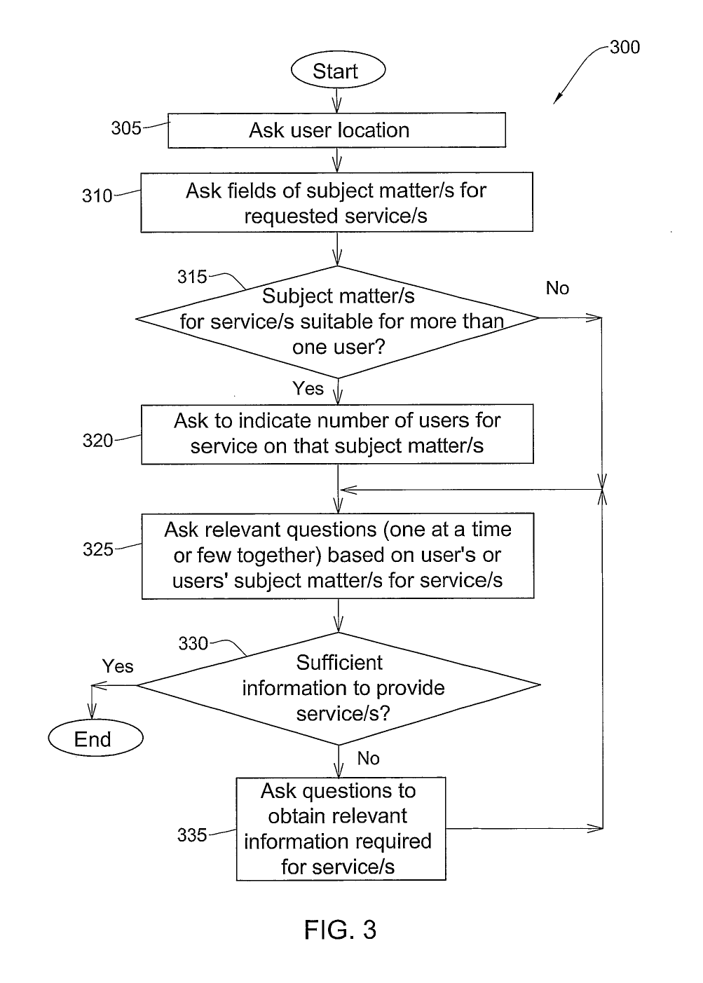

In one embodiment, described further below with respect to FIG. 3, the user is first asked to input and therefore inputs the type of requested service (and possibly scope of service), and is then guided in a series of interactive steps as to what user attributes and preferences are required by the administrative processing system in order that a service provider can provide the requested service.

In one embodiment, some or all of the data inputted by the user may be stored in a memory of the administrative processing system.

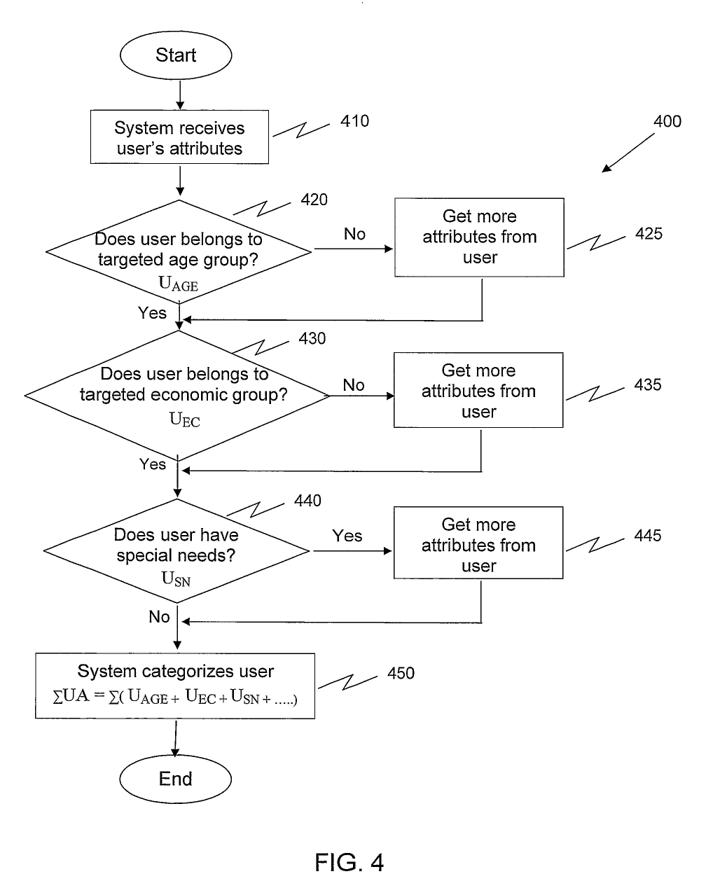

In a checking stage 120, the administrative processing system checks to see if all the information required to provide the service is available (for example has been provided by the user or is otherwise accessible such as from memory). For example, the system can check if all user preferences and user attributes that are required for providing the requested service (within any defined scope of services) are available, that the user has requested at least one service (and if necessary defined scope of service for requested service), and/or that the user preferences and user attributes correspond to the requested service (within any defined scope of service). If yes, the administrative processing system proceeds to the next stage. If not, the system will request the user to provide the lacking user attributes, user preferences and/or user requests that are still required. One embodiment of the details of this stage and stage 115 with respect to user attributes is exemplified with respect to FIG. 4 hereinbelow. In another embodiment, checking stage 120 may be omitted.

It should be understood that stages 115, 120 may be performed a large number of times in various combinations and permutations known in the art. Most typically although not necessarily, all of the requests for inputs and inputs will be from and to the same website, though other alternatives and combinations thereof are envisaged.

It should also be understood that stages 115 and 120 may be performed over a time interval of any length. For example, in some embodiments, a user may provide inputs over more than one session. Continuing with the example, in one of these embodiments a user may be prompted by the administrative processing system to finish inputting data, for example via an email message to an email address supplied by the user.

In one embodiment, the user may have the opportunity to pause the inputting at any point in stage 115 and continue with stage 115 (inputting) later, or abort the inputting at any point in stage 115 (i.e. delete one or more service requests).

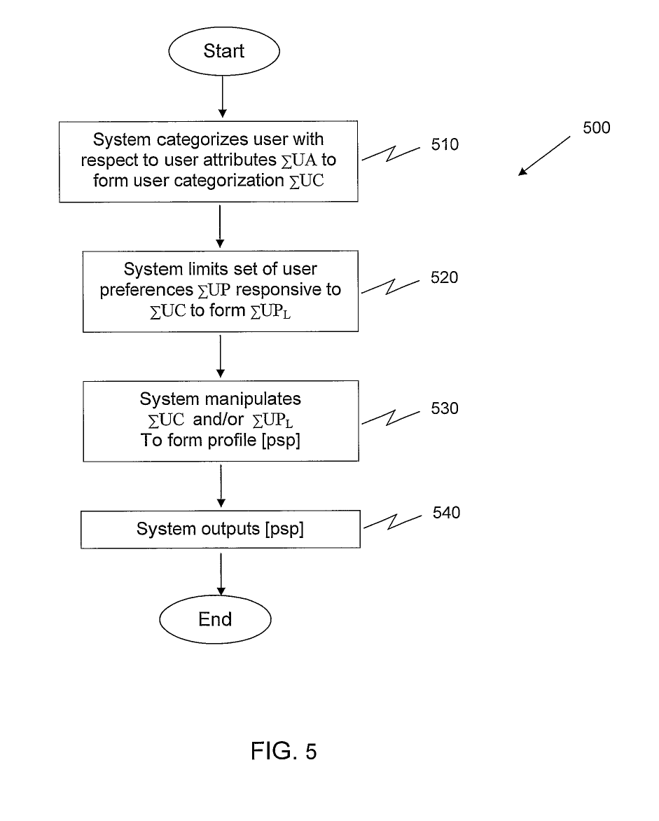

In a processing stage 125, the administrative processing system processes at least some of the user attributes, user preferences and/or service request. In one embodiment the processing includes organizing the inputs received from the user and/or information otherwise accessible such as from memory. In one embodiment, this stage may be performed in accordance with the process of FIG. 5 hereinbelow.

This stage may be performed automatically by the system. In some embodiments, a professional may manipulate the data inputted by the user. In some other alternative embodiments, a combination of a system and a professional process the data.

In some embodiments, processing stage 125 may lead to a conclusion that the subject for which the user asked for service is not available by the referring service provider or alternatively to the conclusion that the service is not available from any affiliated service provider. If the service is not available from the referring service provider, then, depending on the embodiment, method 100 may end after stage 125 with a notice to the user that the service is not available and without charge, or method 100 may continue, but the job may be directed to an appropriate (non-referring) affiliated service provider in stage 145. If the service is not available from any affiliated service provider method 100 will end after the user is notified that no service can be provided to him and he will not be charged any fee. Additionally or alternatively, prior to ending method 100, the administrative processing system may link the user to at least one or more appropriate website and/or to at least one (unaffiliated) professional in the required field.

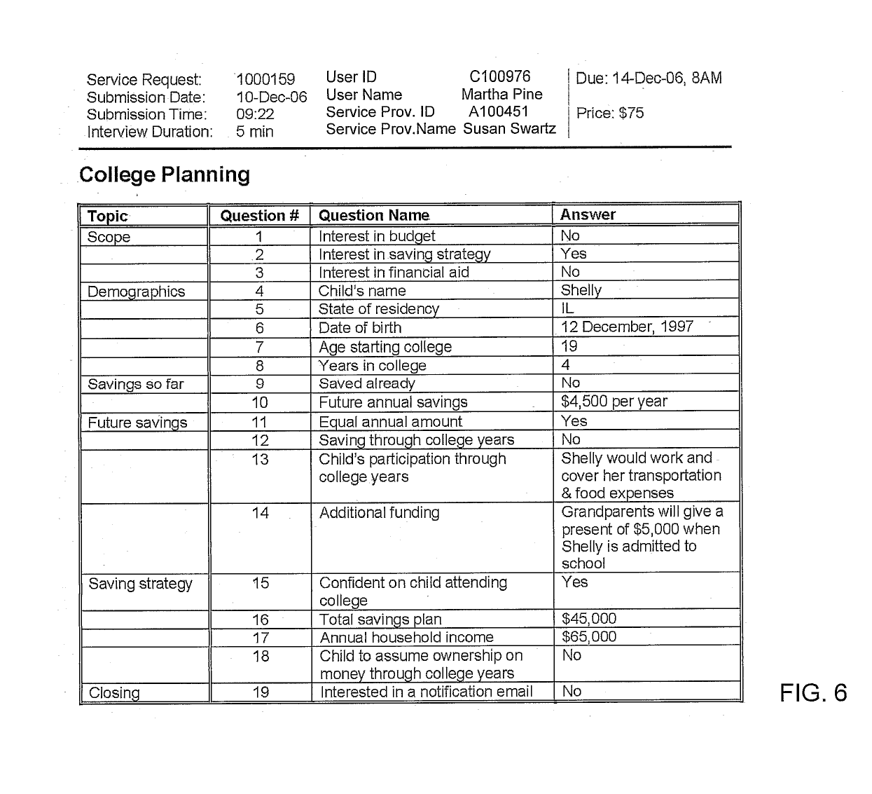

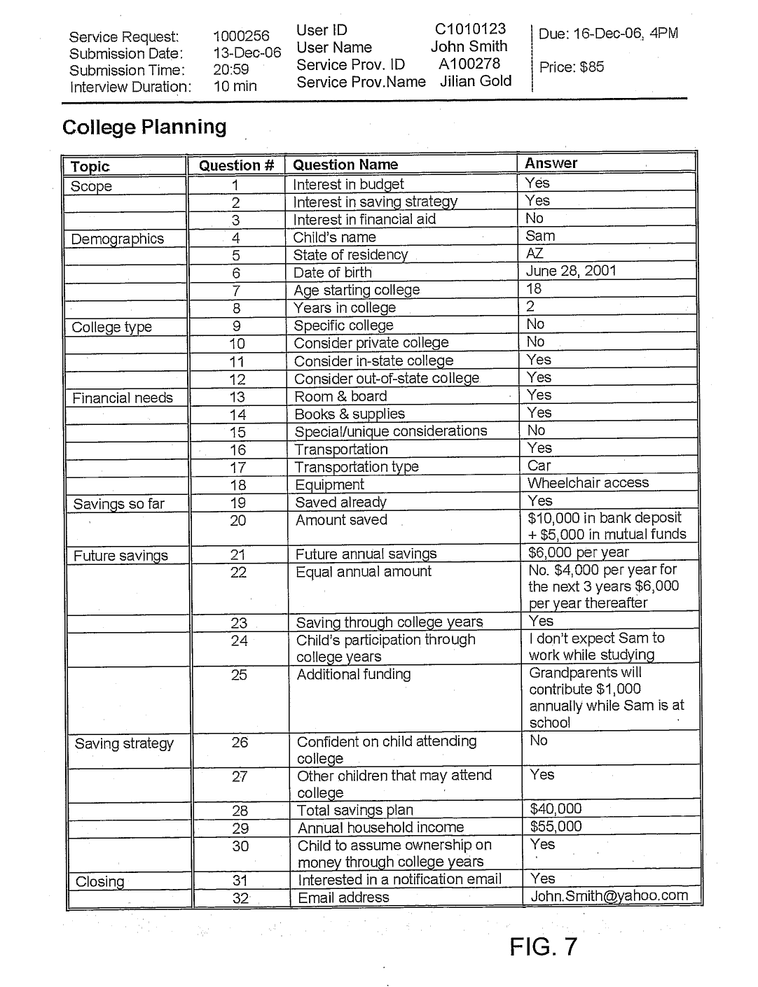

Assuming the service can be provided, thereafter in a definition stage 130, which may, in some embodiments, be integrated with stage 125, the administrative processing system develops a personalized service profile to be used by the service provider in providing the service. The personalized service profile can be thought of as a vehicle for arranging the organized inputs from the user and/or other data known from elsewhere (for example from memory) which are considered sufficient for the service provider to be able provide the service. It should be understood that in some cases, the personalized service profile may not be sufficient and more data may be required at a later date. The format and/or content of the personalized service profile is not limited by the invention. In one embodiment, the personalized service profile will be customized for the service provider which will be providing the service. In another embodiment the format and content of the service profile are uniform for the same type of service request. See for example, FIGS. 6 and 7 described further below for sample service profiles according to an embodiment of the present invention.

This profile may be stored in the administrative processing system memory and/or relayed to the user for verification, as is known in the art. The user may update the profile if desired. In one embodiment, the user may have the option of aborting one or more of the service requests prior to payment.

In stage 135, the administrative processing system receives authorization of payment by the user for the administrative processing and/or service (i.e. the user pays). In another embodiment the payment may be authorized at a different stage of method 100. In one embodiment, a payment request is generated and transferred to the user. In one embodiment, stage 135 may require the user to provide his credit card, debit card or bank information details, to confirm already known user financial details (for example as stored in memory), and/or to confirm payment and/or stage 135 may include the receipt of authorization of one or more financial transactions from the credit/debit card company or bank. However, other ways known in the art for payment may be applied instead.

In stage 140, the delivery terms for the service are provided to the user. In another embodiment, the delivery terms are provided to the user at a different stage of method 100. In some cases, the delivery terms are customized to the service provider. In some cases, the delivery terms may be provided by the user or negotiated by the user. In some embodiments, stage 140 may be omitted (i.e. delivery terms not provided to the user). For example, in one of these embodiments, delivery terms may be independently decided without the intervention of the administrative processing system (for example decided by the user and/or service provider).

In one embodiment, the delivery terms specify that service is provided within a certain time frame (e.g. 48 hours) after the user's request for service has been submitted.

In one embodiment, the user is provided with a password allowing him to enter the website of the administrative processing system and review the completed service (i.e. service output), when ready.

In one embodiment, stages 135 and/or 140 may be performed prior to stage 130, for example if data from either of these stages is included in the personalized service profile defined in this embodiment.

In another embodiment, stage 140 may be omitted.

In stage 145, the job is sent to a service provider. The sent job includes the service profile defined in stage 130 and possibly other information, for example information on past service requests by the customer, analysis of the data inputted by the user (as will be explained in more detail below), etc.

The service provider to whom the job is sent may be the one who directed the user to the administrative processing system or the service provider may be any appropriate service provider. In one embodiment, jobs relating to users from different countries may be sorted and addressed to relevant service providers pertaining to the relevant country and/or each subject matter.

In stage 150, the administrative processing system confirms receipt of the job by the service provider. In another embodiment, stage 150 may be omitted.

In stage 155, the administrative processing system provides information to the user regarding the service provider. For example in one embodiment the administrative processing system may provide at least one of the following, but not limited to, contact information on the service provider, a copy of the job transmitted to the service provider, a confirmation of receipt by the service provider, or a reference job number. In another embodiment, stage 155 may be omitted.

In stage 160, the administrative processing system “parks” until the service (job) is completed by the service provider. It should be understood that even if the administrative processing system is waiting for a service to be completed, the administrative processing system may be processing other service requests during this time (i.e. performing method 100 for other service requests). In another embodiment, the administrative processing system still performs tasks relating to the service while waiting for the service to be completed in stage 160, such as monitoring the service provider and if necessary nudging the service provider to complete the service, for example through email reminders. In one embodiment, stage 160 is omitted, for example if the delivery of the completed service to the user is not via the administrative processing system but the service provider instead delivers the completed service directly to the user.

In stage 165, the administrative processing system provides the completed service (i.e. service output), for example advice, to the user. In one embodiment, the administrative processing system provides to the user the service output as received from the service provider (i.e. with the same format and content). In another embodiment, the service output provided to the user may in some cases vary in format and/or content from what was received from the service provider. However, in either embodiment, it is assumed that the service output provided to the user is sufficiently similar to the service output received from the service provider that it can be dependably stated in the description herein that the service output received from the service provider is provided to the user. For example, the service output may be provided to the user in some embodiments by posting on a web site or via email. In one of these embodiments, the administrative processing system notifies the user, by email for example, that the completed service is ready for him and may be viewed on the website. Thereafter, the user may have an option to print the website's posting. The user may also be able to email a link to anyone he wishes in order to allow other people to review the posting electronically.

The administrative processing system may in one embodiment store the user's personalized service profile and completed service, for the purpose, inter alia, of providing future service to the same user or to other users if and when appropriate.

In one embodiment the administrative processing system checks the service it provides to one or more users for consistency. In other words, in this embodiment the administrative processing system has a self-checking mechanism for verifying that a first completed service given a set of user inputs provided at one time will be identical to a second completed service given the same user inputs provided at a different time. This mechanism may be automated, but may additionally require the review of one or more professionals. However, in another embodiment, two users (or the same user two different times) may receive different services given the same inputs.

In an embodiment where the service provider provides the service directly to the user, stage 165 may be omitted (i.e. in this embodiment the administrative processing system is not responsible for providing the completed service to user).

The service provided to the users in some embodiments includes advice. In some of these embodiments, the advice may include recommendations for an action plan and possible recommended entities with whom the recommended plan can be carried out. In one of these embodiments, the advice may recommend entities for the user to work with and carry out the recommended action plan. For example, a particular service provider may indicate that he can assist the user in carrying out the recommended action plan.

The user may have an option to obtain service on more than one issue. In that case, the service may advise to combine action plans in both subject matters such that the combined plan will achieve optimal results for the user. Of course, in such a case the interview process will be longer and will be adapted to the user's particular combination of subject matters for consultancy, in order to provide the service provider with all relevant information required to combine service for all subject matters under consideration.

In one embodiment the service provided by the service providers may include links to other websites that may have articles, graphs or other relevant information.

In some embodiments, the user is asked if the completed service that was received was satisfactory. If negative, the user may be asked if he wishes to receive further service. If affirmative, he may be referred to another service provider or to the same service provider for further service. In one of these embodiments, the user may have the option to change his original inputs prior to being referred to another or the same service provider. If the user wishes to change the original inputs, the user is sent back to stage 115 prior to being referred to the same or different service provider. Depending on the embodiment, the user may or may not be charged an additional fee.

In one embodiment the fee that is paid by the user is shared by the administrative processing system with the service provider. In one embodiment, the fee that is paid by the user is shared by the administrative processing system with the service provider only if the service provider directed the user to the administrative processing system.

In stage 170, assuming the fee is shared with the service provider, at least part of the payment is transferred to the service provider. The invention does not limit how the payment is shared between the administrative processing system and the service provider. In one embodiment, the payment charged to the user and/or the percentage transferred to the service provider may vary based on at least one criterion selected from the following, but not limited to, whether the service provider directly provides the service to the user or the completed service is provided by the administrative processing system to the user, whether or not the administrative processing system is responsible for nudging the user to provide missing information and/or the service provider to complete the service, whether or not the service provider directed the user to the administrative processing system, whether or not the service provider has a preferred relationship with the administrative processing system, whether or not the service request was complicated (for example based on the number of questions asked of the user), whether or not the payment includes payment for the service and administrative processing, just for the service or just for the administrative processing, etc.

The transfer of at least part of the payment to the service provider may be performed in any suitable matter. For example in one embodiment, the service provider may have an account with the administrative processing system which is credited on an ongoing basis as the service provider performs services, or periodically (for example monthly). As another example, in one embodiment, payments may be transferred to the service provider or to an external account held by the service provider on an ongoing basis or periodically.

In one embodiment, stage 170 may be performed earlier in method 100, for example in conduction with stage 135.

In embodiments of the invention, fewer, more and/or different stages than those shown in FIG. 1 may be executed. In embodiments of the invention one or more stages illustrated in FIG. 1 may be executed in a different order and/or one or more groups of stages may be executed simultaneously.

Reference is now made to FIG. 2, which is a block diagram of a configuration 200 for providing a user with a service, for example including advice, in accordance with an embodiment of the present invention.

In configuration 200 there any number of users 208, for example m users 208, each configured to communicate with administrative processing system 250 and/or with any number of service providers 210, for example n service providers 210, via a communication network 225. Illustrated in the figure are first user 202, second user 204, mth user 208, first service provider 212, second service provider 214 and nth service provider 216 however it should be understood that the illustration of three users and three service providers is a non-limiting example. For simplicity of illustration communication network 225 appears in FIG. 2 as one communication network which is the same for all communications involving any user 208, however it should be understood that embodiments of the invention envision one or more communication networks 225 between each user 208 and service provider(s) 210, and/or one or more communication networks 225 between each user 208 and administrative processing system 250, where each communication network may be the same or different from others. For ease of description, communication network 225 is referred to in the single form herein below but should be understood to include embodiments with one or more communication networks. Communication network 225 may be wired, wireless, or partly wired and partly wireless.

Depending on the embodiment, any user 208 may use any appropriate communication device to communicate via communication network 225. Examples of communication devices include, but are not limited to, personal computers mobile telephones, lap-top computer, interactive television sets, wired telephones, facsimiles, personal digital assistants, etc.

In some embodiments, service providers 210 are available for both online (i.e. via communication network 225) communications with users 208 and off-line communications with users 208. In some of these embodiments, communication network 225 may not be used by a particular user 208 to contact a specific service provider 210. In one of these embodiments, the particular user 208 may pay a personal visit to specific service provider 210 or may not communicate directly with specific service provider 210 (but only with administrative processing system 250).

According to an embodiment of the invention, a specific user 208 uses a communication device to connect up to the Internet and access the World Wide Web, and more specifically to access a website of a particular service provider 210. However in other embodiments, the specific user 208 may communicate with the particular service provider 210 without visiting the service provider's website.

Depending on the embodiment, any service provider 210 may communicate with administrative processing system 250 via any suitable communication network 285. For simplicity of illustration communication network 285 appears in FIG. 2 as one communication network which is the same for all communications involving any service provider 210 and administrative processing system 250, however it should be understood that embodiments of the invention envision one or more communication networks 285 between each service provider 210 and administrative processing system 250, where each communication network may be the same or different from others. For ease of description, communication network 285 is referred to in the single form herein below but should be understood to include embodiments with one or more communication networks. Communication network 285 may be wired, wireless, or partly wired and partly wireless. Communication network 285 may be the same, partly the same, or different than communication network 225.

Depending on the embodiment, any service provider 210 may use any appropriate communication device to communicate via communication network 285. Examples of communication devices include, but are not limited to, personal computers mobile telephones, lap-top computer, interactive television sets, wired telephones, facsimiles, personal digital assistants, etc.

For the sake of simplicity of description herein and below of configuration 200, it is assumed that service provider 214 provides the service to user 202, and therefore reference is made to user 202 and service provider 214, however service provider 214. servicing user 202 should be understood to be but one example.

In some embodiments, by visiting the web site of service provider 214 or via any other means (for example by email, by phone, by a personal visit, etc), user 202 may receives the contact information for contacting administrative processing system 250 from service provider 214. In some of these embodiments, user 202 receives a website address of administrative processing system 250. For example in one of these embodiments, by clicking on a link on a website of service provider 214, user 202 is linked with the website of administrative processing system 250. In one embodiment where user 202 receives the contact information of administrative processing system 250 from service provider 214, user 202 also receives an indication of the identification of service provider 214 which user 202 then provides to administrative processing system 250. In some embodiments where user 202 receives the contact information of administrative processing system 250 from service provider 214, user 202 indicates the requested service to service provider 214, and data related to the requested service is returned by service provider 214 to user 202 for subsequent provision to administrative processing system 250. For example in one of these embodiments, a reference code for the requested service, and/or a standardized name of the requested service is returned to user 202.

In one embodiment, the website of service provider 214 may provide an introduction to the administrative processing system 250. For example, assuming the administrative processing system 250 in this embodiment is considered flexible in customizing the processing of the user for a particular service provider (and/or considered to possess any other characteristic(s)), the introduction can explain the flexibility (and/or other characteristic(s)) of administrative processing system 250.

In some embodiments, user 202 may know how to contact administrative processing system 250, without first receiving contact information from any service provider 210. For example, in one of these other embodiments, user 202 may not have a lo service provider or user 202 may be a returning user (i.e. has previously contacted administrative processing system 250).

In one embodiment, user 202 uses a communication device to connect up to the Internet and access the World Wide Web, and more specifically to access the website of distractive processing system 250. In one embodiment, the website, Internet/Intranet communication system may be as described for example in any of the references cited herein, which are incorporated herein by reference. Additionally or alternatively, the website may be on some other type of web to be constructed in the future.

However in other embodiments, user 202 may communicate with administrative processing system 250 without visiting the website of administrative processing system 250.

Although for simplicity of illustration the elements of administrative processing system 250 are illustrated in FIG. 2 as though concentrated in one location, depending on the embodiment elements of processing system 250 may be dispersed over more than one location or concentrated in one location. Elements included in the embodiment of administrative processing system 250 illustrated in FIG. 2 will now be described.

A user communications manager 252 is configured to manage the communications between user 202 and administrative processing system 250 in some embodiments of the invention. Assuming for ease of explanation that in one of these embodiments, the user accesses a website of administrative processing system 250, user manager 252 provides different web pages to a web browser on the communication device of user 202, and thus communicates with user 202. In one embodiment user manager 252 supports international inquiries from around the world in and may be constructed to provide services in a number of languages.

In one embodiment of the invention, user 202 may interact with user manager 252 of administrative processing system 250 and perform any of the following, but not limited to: register for administrative processing system 250 (including any of the following: provide initial user data such as an email address and a password, modify user password, etc), answer questions asked by user manager 252, accept service terms and quote, pay for the service, and/or control the pace of communication with user manager 252 (including any of the following: pause answering questions, resume answering questions, stop answering questions, start answering questions, quit interaction, view service requests, delete service requests, etc).

In one embodiment, when user 202 contacts user manager 252 of administrative processing system 250, user 202 provides the identification of service provider 214. In another embodiment, however, user 202 does not provide the identification of service provider 214, for example because user 202 has not selected a particular service provider. User manager 252 may identify the requested service by user 202 in any appropriate manner. For example in one embodiment, when user 202 contacts user manager 252 of administrative processing system 250, user 202 indicates the service requested (for example using the data received from service provider 214) whereas for example in another embodiment, user manager 252 determines the service requested implicitly (for example based on an identification of service provider 214 provided by user 202) or explicitly (for example by asking user 202). In some embodiments, the format and/or content provider by user manager 252 to user 202 is customized for service provider 214. For example, in one of these embodiments the logo of service provider 214 may appear on a web page presented to user 202.

A service provider communications manager 268 is configured to manage the communications between service provider 214 and administrative processing system 250 in some embodiments of the invention. In one embodiment service provider manager 268 supports international inquiries from around the world in and may be constructed to provide services in a number of languages. In one embodiment, the functionality of provider manager 268 and user manager 252 may be integrated into a single module, however for simplicity of description herein provider manager 268 and user manager 252 are distinguished by separate reference numerals.

Illustrated in configuration 200 are database of service providers 254, database of users 256, and/or database of questions 258. In one embodiment, user manager 252 may use any of the databases described herein inter-alia in order to better manage the communication with users and/or to store data received during communications with users. In one embodiment, provider manager 268 may use any of the databases described herein inter-alia in order to better manage the communication with service providers and/or to store data received during communications with service providers. In other embodiments, user manager 252 and/or provider manager 268 may be configured to only access a subset of databases 254, 256, and 258. Although databases 254, 256, and 258 are illustrated as separate databases, it should be understood by the reader that one or more of databases 254, 256 258, and/or of other databases may be integrated together. In other embodiments, any of databases 254, 256 and/or 258 may be omitted. Other embodiments may include databases storing other types of information instead of or in addition to any of databases 254, 256 and/or 258. In one embodiment, user manager 252 and/or provider manager 268 may access databases which are not part of administrative processing system 250, for example databases that belong to service providers, in addition to or instead of databases that are part of administrative processing system. For example in one embodiment, user manager 252 and/or provider manager 268 may prolong communications with users and/or providers respectively in order to obtain data which in other embodiments would have been stored in databases.

Service provider database 254 may store per service provider, any appropriate information which may vary depending on the embodiment. For example, in one embodiment, service providers may build, test, approve and/or maintain the content of some or all of the interaction users, independently or with the assistance of administrative processing system 250. In this embodiment, service provider database 254 may store, for any particular service provider, (all or part of) the content or a framework for developing (all or part of) the content (for example references to questions in database 258) of interactions with users which will be serviced by a particular service provider. As another example, in one embodiment service provider database 254 may include additionally or alternatively a comparison of performances of different service providers. As another example, service provider database 254 may include additionally or alternatively financial information relating to the providers (for example a record of paid and/or unpaid transactions, where to send payments for each provider, status of account held with administrative processing system 250, etc). As another example, service provider database 254 may include additionally or alternatively workload information (for example a summary record of services provided by each service provider, desired workload for each service provider, current workload of each service provider, etc.).

As another example, service provider database 254 may include additionally or alternatively service request information (for example a summary record of services per service provider including the status of the services (open, or complete), personalized service profiles per service provider categorized in any appropriate manner, completed services per service provider categorized in any appropriate manner, etc). Continuing with the example, the open status may refer to service requests which are currently being handled and the complete status may refer to service requests whose services have already been provided. As another example, service provider database 254 may include additionally or alternatively personal information relating to service providers (for example resume, public profile, services offered, experience, licensing by location, education, rating/rank by users, preferred (or not preferred) relationship with processing system 250, etc).

Depending on the embodiment, information from service provider database 254 may be accessible by users, not accessible by users, or partially accessible by users. For example in one embodiment, each service provider may have the option of developing a public profile which is stored in database 254 and is accessible to users along with a rating/rank from user feedback on that service provider 210. Depending on the embodiment, information on a particular service provider from service provider database 254 may be fully accessible by any service provider, may be partly accessible by any service provider, may not be accessible by any service provider 210, may be fully accessible by the particular service provider, may be partly accessible by that particular service provider, and/or may not be accessible by that particular service provider. For example in one embodiment, any service provider may access the public profile and the rating/rank of a particular service provider, and the particular service provider may access all the information on that particular service provider in database 254. In some embodiments, service providers may be equipped with means to control, update, add, delete, extract and/or change some data stored in administrative processing system 250. For example, in one of these embodiments, a particular service provider may control, update, add, delete, extract and/or change at least some of the data related to the particular service provider in service provider database 254.

Database of users 256 may store per user any appropriate information which may vary depending on the embodiment. For example in one embodiment, database 256 may include payment information for users, so that in some cases returning users may not be required to again provide payment information or in order to verify payment information submitted by returning users. As another example, user database 256 may include additionally or alternatively service request information (for example, a summary record of services provided per user including the status of the services (missing, open, or complete), personalized service profiles per user categorized in any appropriate manner, completed services provided by service providers per user categorized in any appropriate manner, user feedback, etc.) Continuing with the example, the missing status may refer to service requests for which there is missing information that is required to provide the service; the open status may refer to service requests which are currently being handled by service providers, and the complete status may refer to service requests whose services have already been provided to the requesting users. Depending on the embodiment, a particular user may or may not be able to fully or partly access information in user database 256 on that particular user. Depending on the embodiment another user may or may not be able to fully or partly access information on a particular user in database 256. Depending on the embodiment, any service provider may or may not be able to fully or partly access information in user database 256 on any user. Depending on the embodiment, a service provider who is providing or has provided a service to a particular user may or may not be able to fully or partly access information in user database 256 on that particular user.

Question database 258 includes data relating to questions which may or may not be posed to any particular user. For example, depending on the embodiment, the actual questions posed to users may be stored in database 258 or logic in database 258 may allow questions which are posed to users to be formulated ‘on the fly’.

In one embodiment user manager 252 selects questions from database 258 (or formulates the questions) to be asked to user 202, according to one or more of the following criteria, but not limited to, questions to establish user identity (e.g. user name, password), initial registration questions (for example for first time users whose information is not in user database 256), payment information questions (for example if not in user database 256), questions to determine service requested (if not yet known) and scope of service, questions relating to requested service and/or scope in order to determine user attributes and preferences, questions to determine desired delivery date, questions to determine desired path of delivery ( for example directly from service provider or via processing system 250), questions to determine desired mode of delivery (for example by email, web site posting etc).

In some cases, user manager 252 may vary some or all of the questions asked to user 202 so as to customize the questions to service provider 214 (for example based on the content of some or all of the questions and/or the framework of some or all of the questions which in one embodiment is stored in database 254 or 258). In one embodiment, user manager 252 may vary some or all of the questions asked based on user answers. In one embodiment, some or all of the questions asked to user 202 may be skipped if the answer is predefined/known, for example based on attributes, preferences, requirements and/or standards of one or more of the requested service, service provider 214, user 202 (for example as stored in user database 256) and/or administrative processing system 250.

In some embodiments, user 202 may request as part of an interaction with user manager 252 that user manager 252 provide a list of service requests (past and/or present), which in one of these embodiments may be developed based on information from user database 256.

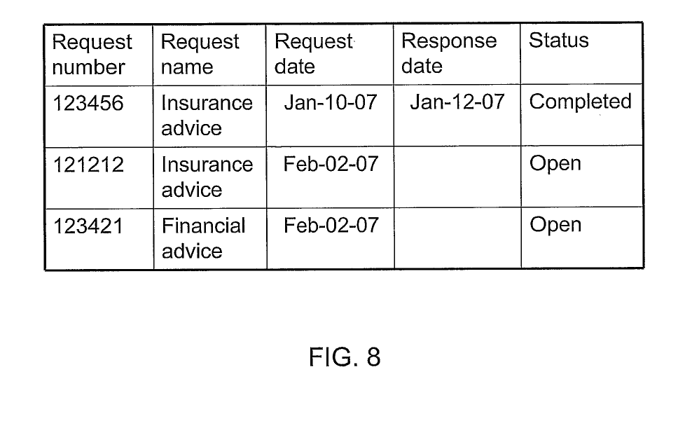

FIG. 8 illustrates a list of service requests which may be provided to user 202 by user manager 252, according to an embodiment of the invention. As shown in FIG. 8, each service request on the list includes a request reference number, a request name (for example as nicknamed by user 202, administrative processing system 250, and/or the assigned advisor 210), a request date, a response (delivery) date, and a status (missing, open, or completed). If the status is missing (i.e. not all information required for the service is known-more user inputs are required), then in one embodiment, all fields other than the request reference number and request name fields are blank. In one embodiment, by clicking on one of the service requests (with open or completed status), the corresponding personalized service profile and/or completed service (as received from the service provider) is displayed to user 202.

In some embodiments, as part of an interaction with user manager 252, user 202 may request to complete a service request whose status is listed as missing (i.e. in these embodiments user 202 does not need to provide all inputs in one session). In one of these embodiments, each time user 202 logs in, user 202 is first prompted to provide any missing information. In one of these embodiments, user 202 receives reminder email(s) to provide any missing information, for example with a link to the “missing” service request.

Assume that user 202 has accessed administrative processing system 250 in order to fill out a service request (new or whose status is missing). In one embodiment, as user manager 252 receives inputs from user 202 (for example as answers to questions), an input checker is configured to check the inputs to determine if all the information required to provide the service has been inputted or is otherwise known (for example from user database 256). If not, user manager 252 continues to interact with user 202 until the necessary information has been collected. In another embodiment, input checker 260 may be omitted if the inputs are not checked.

Once sufficient information has been gathered and service can be provided by service provider 214, a job is defined by job definer 264. The job definition includes a personalized service profile, and possibly other information such as, information on past service requests by the customer, analysis of the data inputted by the user (as will be explained in more detail below), etc. As mentioned above, the personalized service profile can be thought of as a vehicle for arranging the organized inputs from the user and/or other data known from elsewhere (for example from memory) which are considered sufficient for the service provider to be able provide the service. It should be understood that in some cases, the personalized service profile may not be sufficient and more data may be required at a later date. The job definition may be stored in database 254 and/or 256. Optionally another database may additionally or alternatively store job definitions (open and/or complete). The job definition, in one embodiment is provided to user 202 (and/or user 202 may be informed that the job definition is accessible, for example in user database 256).

FIGS. 6 and 7 illustrate examples of personalized service profiles developed by job definer 264, according to an embodiment of the present invention. Both personalized service profiles in FIGS. 6 and 7 relate to college planning and include in the illustrated embodiment, a service request reference number, the date and time of submission, the duration of the interview session, a user identification number and name, a service provider identification and name, a date of delivery (due date), and a price (payment for the service, including the administrative processing). The first series of questions relate to the scope of the requested service. It is noted that in the embodiment illustrated in FIGS. 6 and 7 a service request may include one or more related sub-services which together define the scope of the service. However in other embodiments, each sub-service may be considered a separate service request, with a separate personalized service profile and therefore a separate job definition.

It is also noted that in FIG. 7, the user requests both a budget and a saving strategy and therefore the number of questions and content of questions differs from the personalized service profile of FIG. 6 where only a saving strategy is desired. Both FIGS. 6 and 7 include questions on demographics, savings so far, future savings, saving strategy, and closing (follow up). However FIG. 7 also includes budget related questions, for example relating to college type, and financial needs. It should also be noted that certain questions may or may not be asked in any given category in the embodiment illustrated in FIGS. 6 and 7. For example, in the savings category, only in FIG. 7 where a user indicated that the user has already saved, is a question subsequently asked on the amount already saved, whereas in FIG. 6 the follow up question on the amount already saved is not asked. In one embodiment, the questions asked allow a user to input user attributes and/or preferences relating to the service requested (and any defined scope of service).

The reader should understand that the personalized service profiles illustrated in FIGS. 6 and 7 are examples only which are not necessarily representative. The content and/or format of the personalized service profile is not limited by the invention and may vary depending on the embodiment.

The job definition is transferred to service provider 214 (and/or service provider 214 may be informed that a definition is accessible in database 256).

According to an embodiment of the invention, user manager 252 provides the job definition to service manager 268 which in turn provides the job definition to the referring service provider 214 who referred user 202 to administrative processing system 250. According to an embodiment of the invention, user manager 252 provides the job definition to service manager 268 which in turn provides the job definition to service provider 214 who is selected based on at least one criterion selected from the following but not limited to: current workload versus desired workload, service provider geographical licenses, service provider offered services, service providers previous work with same user, service providers “preferred relationship”, and/or any other suitable criterion. Therefore in this embodiment, the job definition is not necessarily provided to the referring service provider (i.e. the service provider who provides the service is not necessarily identical to the referring service provider), for example if there is no referring service provider or if the service requested can not be provided by the referring service provider.

In some embodiments of the invention, service provider 214 provides the completed service (i.e. service output), for example advice, back to provider manager 268 of administrative processing system 250. Provider manager 268 may then provide the completed service to user manager 252 and/or store the completed service in database 254 and/or 256. User manager 252 provides the completed service to user 202, for example by email or in a subsequent website visit by user 202. For example, the completed service may be stored where accessible by user 202, for example in user database 256 and/or service provider database 254, assuming database 256 and/or 254 is accessible to user 202. In one embodiment, provider manager 268 of administrative processing system 250 may send reminders to service provider 214 to complete the service, either as a standard practice or if necessary. In one embodiment, administrative processing system 250 provides to user 202 the service output as received from service provider 214 (i.e. with the same format and content). In another embodiment, the service output provided to user 202 may in some cases vary in format and/or content from what was received from service provider 214. However, in either embodiment, it is assumed that the service output provided to user 202 is sufficiently similar to the service output received from service provider 214 that it can be dependably stated in the description herein that the service output received from service provider 214 is provided to user 202.

In one embodiment of the invention, service provider 214 directly contacts user 202 (via network 225 or otherwise) to provide the completed service, in addition to or instead of sending the completed service to administrative processing system 250.

In one embodiment, service providers are capable of performing any of the following functions, but not limited to: customizing the administrative tasks performed by administrative processing system 250 (including any of the following: building interviews for gathering required data from a user, testing interviews, approving interviews, maintaining interviews, configuring and maintaining services prices and delivery terms, etc.), providing services (including any of the following: managing delivery schedules, receiving jobs and completing the requested services, submitting invoices and getting paid by administrative processing system 250, viewing the job queue and prioritizing or reprioritizing the job queue, contacting users for clarifications relating to jobs, etc), performing marketing (including any of the following: listing and describing services offered, creating and maintain public profile on administrative processing system 250, updating personal information such as for example locations where licensed to provide services, initiating mass mailings to past users that were customers for follow up and/or marketing, etc), and/or performing analysis (including any of the following: analyzing performance in a specific period or trend analysis, viewing user for example of a customer, viewing past service requests of the same or similar nature, etc). In some cases, provider manager 268 manages the interaction between service providers and administrative processing system 250 so as to facilitate the performance of any of these functions by service providers.

In the illustrated embodiment of configuration 200, a payment processor 270 is configured to handle payments by user 202. The handled payment may be for the administrative processing and for the service, or just for the administrative processing, depending on the embodiment. In some cases, payment processor 270 uses any of databases 254, 256, and/or 258 when handling payments. In some embodiments, payment processor is configured to generate a payment request for user 202 and/or monitor payment by user 202. In one of these embodiments the payment request is transferred to user 202 via user communications manager 252. In some embodiments, payment processor 270 is configured to receive payment information relating to user 202 (for example bank account information, credit card information, etc of user 202) from user manager 252 and/or user database 256. In one embodiment, payment processor 270 checks with one or more financial institutions 280 (for example bank, credit card) and receives authorization for payment by user 202 in accordance with the payment request, as is known in the art. In one embodiment, only after payment authorization has been received will the developed job definition be allowed to be provided to service provider 214. In one embodiment, prior to payment authorization, the user may abort the service request without charge.

In some embodiments, payment processor 270 is configured to share the payment received from user 202 with service provider 214, using any known method to transfer the payment share. In one of these embodiments, payment processor 270 retrieves payment information for service provider 214 from provider database 254 and transfers the payment share of provider 214 according to the payment information. In one of these embodiments, service provider 214 provides payment information to payment processor 270 (for example via provider manager 268). In one of these embodiments, payment processor 270 may inform service provider 214 (for example via provider manager 268) that the payment share for provider 214 is being transferred. In one of these embodiments, payment processor 270 transfers the payment to service provider 214 on an ongoing basis as services are performed. In one of these embodiments, payment processor 270 periodically adds the total amount of money owed to provider 214 (for shares of payments received from users), informs provider 214 of the total and transfers the total. In some of these embodiments embodiment, the transfer of the payment share may be directly to service provider 214, to an external account of service provider 214 or to an account of service provider 214 held with administrative processing system 250. In one of these embodiments, payment is shared with service provider 214 after service provider 214 has completed the service.

In one embodiment, the fee that is paid by user 202 is shared by administrative processing system 250 with service provider 214 only if service provider 214 directed user 202 to administrative processing system 250.

In one embodiment, the payment charged to user 202 and/or the percentage of payment retained by administrative processing system 250 may vary depending on any number of factors, including any of the following but not limited to, whether provider 214 directly provides the service to user 202 or the completed service is provided by processing system 250 to user 202, whether or not processing system 250 is responsible for nudging user 202 to provide missing information and/or service provider 214 to complete the service, whether or not service provider 214 directed user 202 to administrative processing system 250, whether or not service provider 214 has a preferred relationship with administrative processing system 250, whether or not the service request was complicated (for example based on the number of questions asked of user 202), whether or not the payment includes payment for the service and administrative processing, just for the service, or just for the administrative processing, etc.

In one embodiment, administrative processing system 250 is configured to perform any of the following, but not limited to, managing service providers (including any of the following, manage service provider commercial agreements, set-up and maintain service provider pricing, set up and maintain service provider delivery terms, monitor compliance of service providers with delivery commitments to users, manage help desk for service providers, manage status of service providers, for example active or inactive, etc), manage interaction with users (including any of the following: maintain content of website, build interviews, test interviews, approve interviews, maintain interviews, monitor usage, manage help desk for users, user billing and collection, etc), and manage service provided by service providers (including any of the following: analyze advisor specific performance, control advisor specific rules such as workload balancing or location licensing, manage referrals to service providers, prepare payment reports and pay service providers, complete service requests, etc.).

Elements illustrated in FIG. 2 may be made up of any combination of software, hardware and/or firmware that performs the functions as defined and explained herein. In embodiments of the invention, configuration 200 may comprise fewer, more and/or different elements than those shown in FIG. 2 In embodiments of the invention, the functionality of configuration 200 described herein may be divided differently among the elements illustrated in FIG. 2 and/or configuration 200 may include additional or less functionality than described herein. In embodiments of the invention, one or more of the elements illustrated in FIG. 2 may have more, less and/or different functionality than described herein.

Reference is now made to FIG. 3, which is a simplified schematic flowchart illustrating an interactive method 300 for receiving user inputs in stage 115 of FIG. 1, in accordance with an embodiment of the present invention. Method 300 is executed by an administrative processing system, for example administrative processing system 250.

In some embodiments, the administrative processing system supports international inquiries from countries all around the world, and in one of these embodiments, the interview is conducted in the user's native language.

In stage 305, the administrative processing system questions the user regarding the user's location, so as to provide a service in conformity with any laws of the location, or to decline providing the service, if illegal in the user's place of residence. In another embodiment, stage 305 is omitted for example if the location is already known (for example from the user database), can be determined implicitly, or the administrative system assumes that the referring service provider is licensed to provide the service in the user's place of residence.

In a questioning stage 310, the user is asked the field of the requested service (including any scope of service). Stage 310 may be omitted for example if the administrative processing system can discern the field of the requested service based on which service provider directed the user to the administrative processing system or if indication of the requested service was transferred (for example via the user) from the service provider who directed the user to the administrative processing system.

In a choosing stage 315 the subject matter for service is checked to see if it is suitable for activating more than one user (e.g. legal consultancy to a seller and to a buyer to purchase a real estate property such as an apartment, or legal consultancy to a seller and a buyer of a car). If yes, the interview process will include a request in an asking stage 320 to indicate number of users. For simplicity of description the single form of user is used herein to include embodiments with a single or multiple users.

In the interviewing stage 325, the interview is typically although not necessarily performed in an interactive smart manner, relevant to the user's subject matter for service. In a checking stage 330 (equivalent to stage 120), the administrative processing system checks to see if sufficient information to provide the service has been received from the user (or is known otherwise, for example from user database 256). If negative, additional questions are asked in stage 335. In one embodiment, the additional questions are based on the user's input at the previous stages. If affirmative, the interview ends after stage 330.

In one embodiment, the interview process is performed electronically in a manner similar to the manner that a user would be interviewed by a service provider face to face in a live interview. The interview's purpose is to provide a service provider with all relevant information and details of the user required in order to be able to provide the service. It should be noted that the questions of the interview may appear one after the other (i.e. one at a time), or several may be grouped together.

In some embodiments of method 300, a user conducts an interactive, “chat like” session in which questions are asked by an automated system (for example the administrative processing system) and the user provides answers. In some of these embodiments, the automated system presents a follow-up question or questions based on the specific answer or answers the user provides to previous questions (where in some cases the answering or not answering by the user may be considered as part of the user answer(s) on which follow up question(s) are based). In one of these embodiments, questions in the interview can be added, deleted and/or changed, based on user answer(s) to previous question(s). In this embodiment, the basing of the content of subsequent question(s) on the answer(s) to previous question(s) (which in some cases may include whether the previous question(s) had been answered or not) may be performed in any appropriate manner, for example by composing the content of subsequent question(s) on the fly, by selecting question(s) with particular content to be the subsequent question(s), by modifying the content of selected question(s) to become subsequent question(s), etc. Thus, the area covered in each interview may in this embodiment vary from user to user.

In one embodiment, the user may provide answers by typing the answers, for example in a designated place or, by choosing an answer from among the choices that the system offers.

In one embodiment of method 300, a user is allowed to put aside a specific question (or questions) and respond to the set aside question(s) later. In one embodiment, a user is able to modify an answer provided already. In these embodiments, the automated system will continue the session incorporating the new or modified information provided by the customer.

In one embodiment of method 300, the automated system can pose a question in more than one manner, for example rephrasing the question in order to overcome a user's concern for privacy.

In one embodiment of method 300, for example for convenience sake, the automated system allows users to stop and re-start their interview, for example if the interview could not be completed in a single session.

In embodiments of the invention, fewer, more and/or different stages than those shown in FIG. 3 may be executed. In embodiments of the invention one or more stages illustrated in FIG. 3 may be executed in a different order and/or one or more groups of stages may be executed simultaneously.

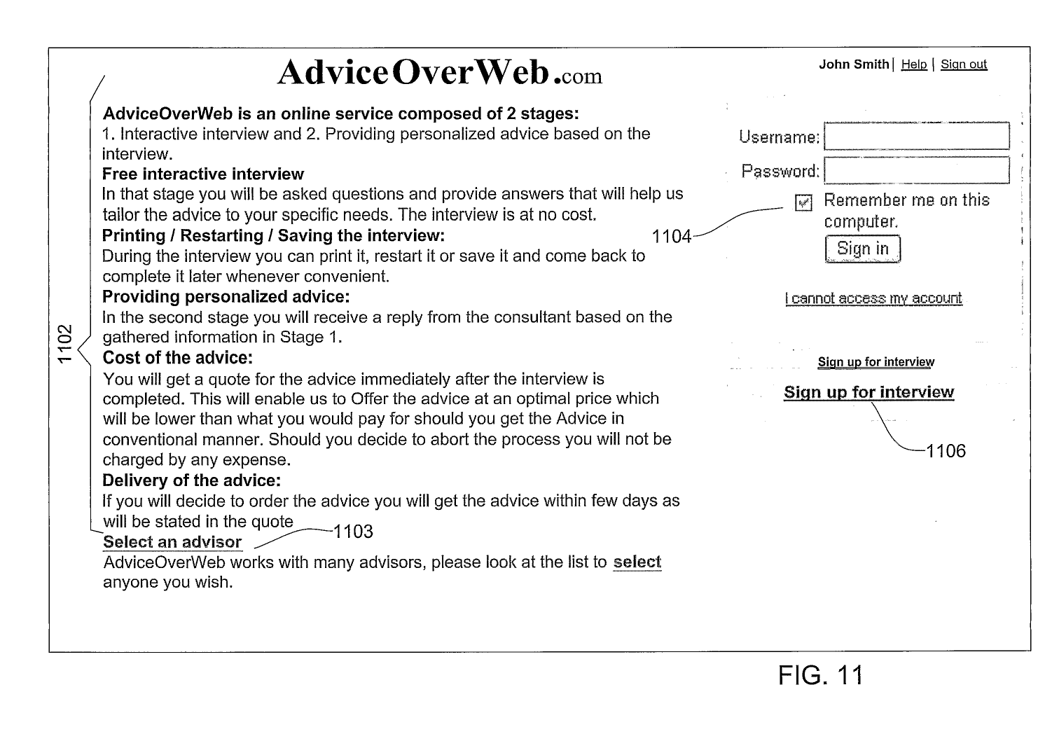

Further below an example of an interactive interview in accordance with one embodiment of the invention is presented with reference to the graphical user interfaces of FIGS. 11 to 31.

Reference is now made to FIG. 4, which is a simplified schematic flowchart of a method 400 illustrating an embodiment of stages 115 to 120 of FIG. 1 with respect to user attributes. Method 400 is executed by an administrative processing system, for example administrative processing system 250.

In a receiving stage 410, the administrative processing system receives user attributes from the user. The administrative processing system checks in first sorting stage 420 to see if the user belongs to a targeted age group U_{AGE}, (for example ‘senior citizens aged 60-75). If the user does not possess the required attribute, he may be asked more questions in an asking stage 425. For example, he may be asked his date of birth and whether he intends to retire early. In a second sorting stage, the user attributes are analyzed with respect to targeted economic group, U_{EC}. For example, the targeted economic group could be users with incomes in a range of $50,000-100,000/annum. If the user does not belong to this group, he may be asked further questions in a second asking stage 435. For example, he may be asked if he runs a business or has additional incomes beyond his salary. If the results in stage 435 show that the user's total income is either above or below the desired range, the user is categorized accordingly. In some cases, the response to the questions will lead to the user falling within the desired range of U_{EC} in stage 430. In stage 440, the user may be categorized as to his special needs, U_{SN}. For example, the targeted special needs may be, for example, that the user be vegan or vegetarian. If the administrative processing system does not have enough information about the user, the user is asked some more specific questions in stage 445 regarding his diet. Using this methodology, the administrative processing system can define whether a particular user belongs to a targeted group (exemplified by vegetarian users, aged 65-80 of income $50,000-100,000/annum). The administrative processing system thus defines the user as belonging or not belonging to a certain user category by assessing a number of user categorizations ΣUC.

This information may be stored by the administrative processing system and used by the administrative processing system and/or by the professional when providing the user with advice. The example shown in this figure is illustrative and like all other examples herein should not be considered to be limiting.

In embodiments of the invention, fewer, more and/or different stages than those shown in FIG. 4 may be executed. In embodiments of the invention one or more stages illustrated in FIG. 4 may be executed in a different order and/or one or more groups of stages may be executed simultaneously.

Reference is now made to FIG. 5, which is a simplified schematic flowchart of a method 500 illustrating an embodiment of stage 125-130 of FIG. 1. Method 500 is executed by an administrative processing system, for example administrative processing system 250.

In a first stage 510, the administrative processing system processes some or all of the information received from the user so as to categorize the user into categories ΣUC. The user may be categorized with respect to age, psychological profile, intelligence, socio-economic group and the like. In some embodiments, this is performed in accordance with the flowchart of FIG. 4.

It should be understood that a large number of parameters/attributes may be received from the individual and that in some embodiments the administrative processing system may process only selected parameters/attributes. Once the user has been categorized, the administrative processing system processes at least some of the user preferences ΣUP responsive to his categorization ΣUC. For example, if the user was categorized as belonging to the group exemplified by vegetarian users, aged 65-80 of income $50,000-100,000/annum, he should not be offered a mortgage with a payback period of 40 years, nor should he be offered a mortgage with a monthly repayment of $10,000/month. This particular user should also not be offered stocks in the local slaughterhouse as this may be offensive to a vegetarian or vegan.

In other words, the administrative processing system will, in some, but not all cases, limit the user preferences to those that are favorable and feasible for the user, responsive to his categorization. Thus, in stage 520, the user preferences ΣUP are limited to a limited set of user preferences ΣUP_{L}.

In a manipulating/processing stage 530, the administrative processing system uses at least one set of rules combining the user categorization, ΣUC, with the limited set of user preferences ΣUP_{L} to form a personalized service profile, PSP.

In an outputting stage 540, the administrative processing system outputs the personalized service profile, PSP.

In embodiments of the invention, fewer, more and/or different stages than those shown in FIG. 5 may be executed. In embodiments of the invention one or more stages illustrated in FIG. 5 may be executed in a different order and/or one or more groups of stages may be executed simultaneously.

Assuming that the job transferred to the service provider in stage 145 includes an analysis of the data inputted by the user, the administrative processing system may analyze the data inputted by the user, prior to transferring the job to the service provider. The administrative processing system may process the personalized service profile, typically although not necessarily using a set of rules and/or at least one algorithm. In some embodiments, the administrative processing system performs the analysis using an algorithm comprising at least one rule, and more typically although not necessarily at least one set of pre-defined rules. The at least one set of rules may be determined according to the type of user request(s) and/or according to the user attribute(s) and/or according to the user preference(s). The set of rules may be selected from, but not limited to accounting rules, actuarial rules, tax rules, ergonomic rules, socioeconomic rules, economic rules, religious rules, national law, international law and medical rules. The rules may be in accordance with any of the above-referenced citations.

The set of actuarial rules, for example, may be in accordance with the actuarial data employed in U.S. Pat. No. 6,963,852 to Koresko, the disclosure of which is incorporated herein by reference.

The set of tax rules may be as disclosed in U.S. Pat. No. 6,993,502 to Gryglewicz et al., for example, the disclosure of which is incorporated herein by reference.

The set of medical rules, may be for example, but not limited to, those disclosed in U.S. Pat. No. 6,725,447 to Gilman et al., and/or to those of U.S. Pat. No. 5,584,445, to Papageorge, the disclosures of which are incorporated herein by reference.

The set of religious rules, may for example, be as defined by the Bible, the Canonical Law, Mormon Law, Protestant Law, the Koran or any other religious Codex, as is known in the art.

In some embodiments, the service sought includes financial advice. The set of rules employed may be any sort of financial rules known in the art. These rules may be based on any theoretical set of rules such as those defined hereinabove. The rules may comprise algorithms and/or any mathematical models and/or expert system manipulations and/or artificial intelligence known in the art. These rules may be used to predict various possible or theoretical outcomes of financial or other scenarios based on the user service requests and/or other user inputs.

In some embodiments, the analysis pertaining to requested financial advice comprises the following substeps: a) the administrative processing system selects at least one set of rules pertaining to a current financial activity of the user and then b) applies the at least one set of rules to the current financial activity so as to provide a corresponding at least one financial prediction. Thereafter the administrative processing system c) compares the at least one financial prediction with the current financial activity. In the next step, d) the administrative processing system chooses a selected financial prediction from the at least one financial prediction, the selected financial prediction corresponding to a selected set of rules and thereafter e) the administrative processing system applies a set of rules corresponding to the selected set of rules to the current financial activity so as to provide a future financial output.

The analysis may in some embodiments result in a suggestion on the service which should be provided to the user (with which the service provider may or may not agree). For example, if the requested service relates to mortgage advice, the analysis may result in the provided service including advice that comprises some alternative options which include, a comparison table of several mortgage options showing their monthly payment level, the duration of the mortgages, the consequences of delayed payment or non-payment of the mortgages, the options for early repayment of the mortgage and the like.

In some embodiments, the analysis can be performed inter-actively with the user. For example, the user may choose one of the options offered. This interactive analysis may be further divided into substeps such as: a) the user choosing a final mortgage sum; b) choosing a preferred payback period and scheme; and c) a preferred building society. In one of these embodiments, the user authorizes his choice by keying in a response, clicking on an icon or any other method known in the art. In some cases, the interactive analysis also includes a verification sub-step and a financial authorization sub-step, as are known in the art. In one of these embodiments, the user is asked by the administrative processing system if he is satisfied with his choice. If affirmative, the administrative processing system completes the analysis.

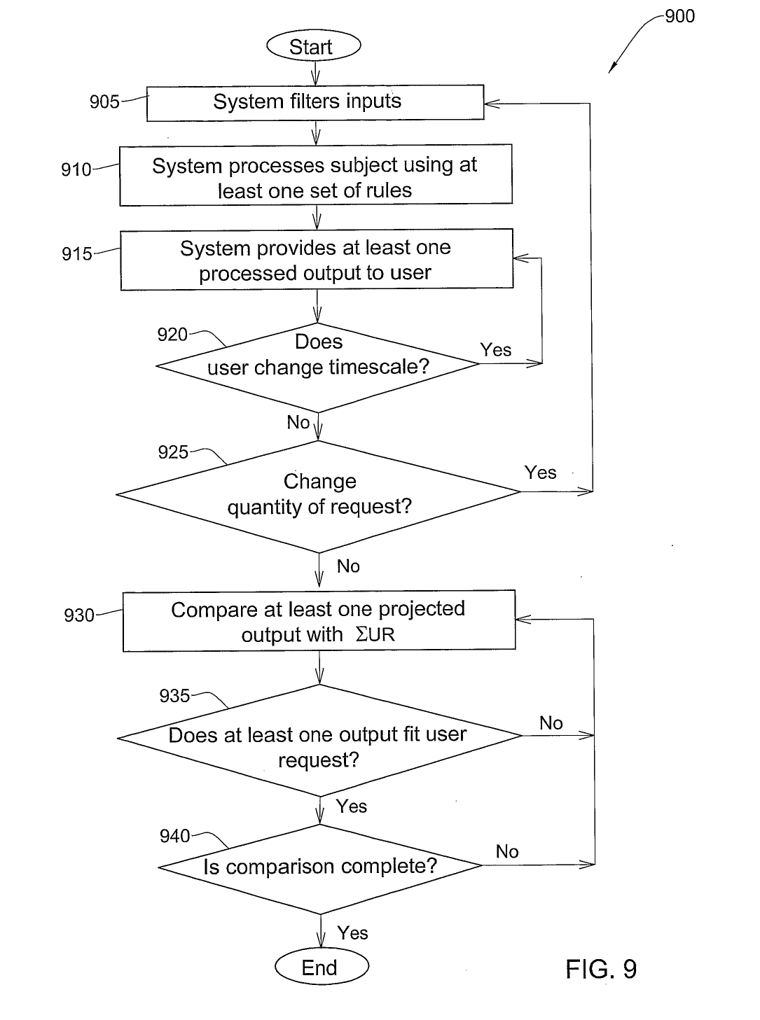

Reference is now made to FIG. 9, which is a simplified schematic flowchart illustrating a method 900 of interactive analysis, according to an embodiment of the present invention. Method 900 is executed by an administrative processing system, for example administrative processing system 250.

Once more, this example is exemplified by a vegetarian user, aged 65-80 of income $50,000-100,000/annum. In one case, the specific male user, aged 67, with an income of $95,000, wants a mortgage of $100,000, to be paid back before the age of 85.

In a second case, the user is female, with an income of $75,000 and wants to pay the mortgage back by the age of 85.

In an optional filtering stage, 905, administrative processing system, filters one or more of the inputs into ΣUR, ΣUP or ΣUP_{L} and PSP. The filtering stage may be in accordance with a set of filtering rules. The filtering rules may be independent, or they may be wholly or partially in the context of the user requests. The rules may be inputted by a professional or by any other technique. Thus, stage 905 outputs sub-sets of ΣURss, ΣUPss or ΣUP_{L}ss and PSPss, wherein the subsets are smaller or equal to the original corresponding sets.

In a processing stage 910, the administrative processing system processes the ρURss, ΣUPss or ΣUP_{L}ss and PSPss, in accordance with one or more sets of rules. These rules are typically although not necessarily in accordance with, but not limited to, the rules defined hereinabove.

In an outputting stage 915, the administrative processing system provides at least one projected output to the user. For example, if referring to a mortgage plan for a $100,000 mortgage, the projected output can be, for example:

a) monthly payment of $1100 for 20 years with an endowment of $60,000;

b) monthly payment of $1050 for 25 years with no endowment; and

c) monthly payment of $1200 for 15 years with no endowment.

In an optional amending stage 920, the first male user and/or the administrative processing system adjusts the payback time to, say, for example, 12 years.

The administrative processing system will then provide a new output to the user in stage 915. For example,

d) monthly payment of $1550 with no endowment; and

e) monthly payment of $1750 with $40,000 endowment.

In optional changing stage 925, the user can change the size of the mortgage. For example, if he increases the mortgage to $120,000, then the administrative processing system will run a check from stage 905 onwards to see if the user can meet the payment criteria.

If no amendment is required in stage 925, the outputs d-e are compared to the user's original requests ΣUR. It is found that both options d) and e) match the user's request. Now, in fitting stage 935, the administrative processing system compares outputs d) and e) for the best fit.

With regard to mortgages, the criteria are for example i) monthly payment ≦20% monthly income; ii) interest rate less than value I; and iii) total cost of mortgage.

The criteria used to check the fit can be any one or more statistical criteria known in the art, such as percentage fit, standard deviation and variance.

Thus, it can be seen upon checking criterion i) against options d) and e), that only d) matches the criterion i) for the first male user and that option e) may be a better deal with respect to iii), but does not meet criterion i). Thus, in stage 935, option e) is rejected and only option d) is to be offered to the user.

In stage 940, option d) may be checked further with regard to the user's current age against the mortgage policy for payments after the age of 75. If all the user requirements and the mortgage requirements are met, the analysis process is considered complete (yes to stage 940).

In the case of the female user, in stage 915, options a), and c) meet the age criterion set by the user. The female user makes no change in stages 920, 925. Now, in stage 930, the administrative processing system compares options a) b) and c) with the user's request. Option b) is rejected on the criterion of payback age at the end of the mortgage being greater than 85.

In stage 935, the administrative processing system determines which of option a) and option c) provides the best fit to the user requests. The administrative processing system may perform calculations based on the best fit of all three criteria i), ii) and iii) using numerical/statistical programs known in the art. For example, applying actuarial rules, the female user may be advised to take option c), and to complete the repayments by the age of 80 rather than 85 for option a), even if a) proves to be a better deal in accordance with criterion iii).

If all the user requirements and the mortgage requirements are met, the analysis is complete (yes to stage 940).

In embodiments of the invention, fewer, more and/or different stages than those shown in FIG. 9 may be executed. In embodiments of the invention one or more stages illustrated in FIG. 9 may be executed in a different order and/or one or more groups of stages may be executed simultaneously.

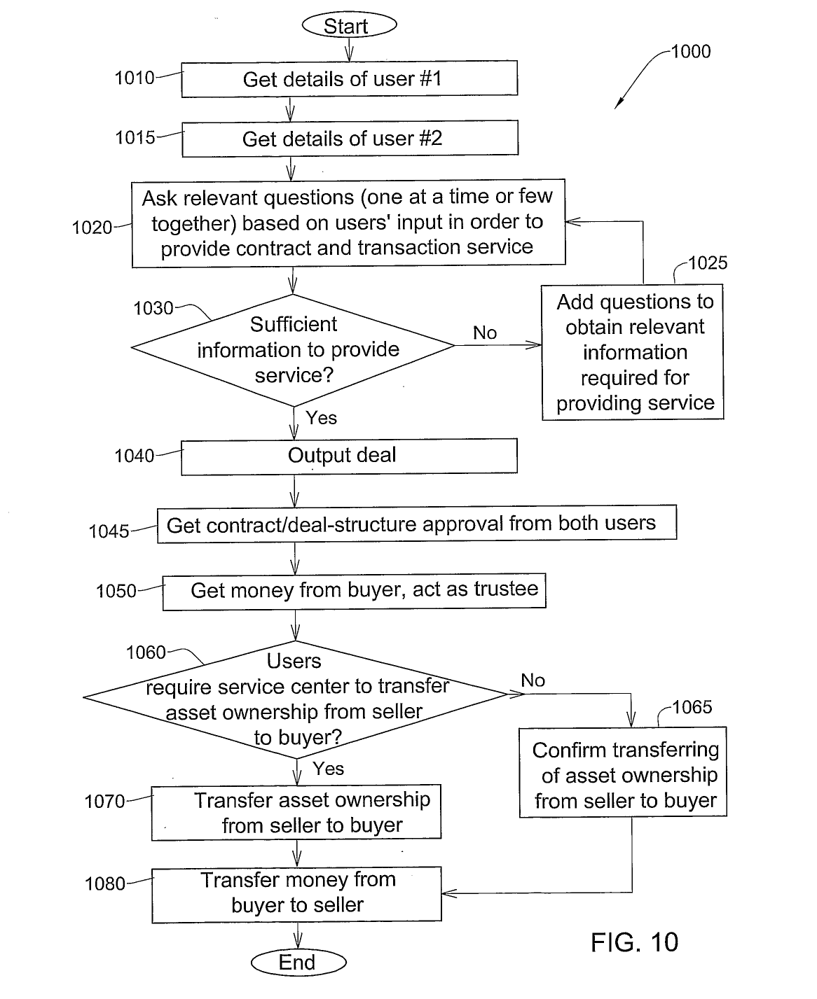

Reference is now made to FIG. 10, which is a simplified schematic flowchart 1000 illustrating a method of providing a financial transaction service involving at least two users, in accordance with an embodiment of the present invention. Method 1000 is executed by an administrative processing system, for example administrative processing system 250.

In a first information obtaining stage 1010, the administrative processing system, obtains the details of a first user. These details may include, but are not limited to, age, gender, address, employment details and financial status, and financial transaction requirements. For example, the first user may wish to sell his house or car. In this stage, the details of many different users may be obtained.

In a second information obtaining stage 1015, the administrative processing system obtains the details of at least a second user. These details may include, but are not limited to, age, gender, address, employment details and financial status, and financial transaction requirements. For example, the second user may wish to purchase a car. In this stage, the details of many different users may be obtained.

In an interviewing stage 1020, both the first and second user/users are interviewed in at least one interview to obtain further details with regard to his/their financial transaction requirements.

In a checking stage 1030, the administrative processing system checks to see if it has sufficient information regarding the users. If, negative, a further questioning stage 1025 is activated to obtain the further information. In some cases, users are eliminated from the option to complete the financial transaction in stage 1020, if the match between the first and second user is not sufficiently good. For example, if the type of car for sale from the first user does not match the requirements of the second user (potential buyer), then the administrative processing system may search for further first users wishing to sell their car. In some other cases, the geographic location or financial status of the user may be unsuitable for completing the transaction.

If the result of checking stage 1030 is positive, the administrative processing system then provides a draft contract to the service provider in stage 1040 to review and/or finalize the draft. Alternatively, in stage 1040, the administrative processing system provides features of a contract to a service provider, for example with legal expertise, to draft the contract.

Once the draft contract is provided by the service provider directly to the users or indirectly via the administrative processing system, in an approval obtaining stage, 1045 the first and second users are asked to provide their approval regarding the contract. This stage may comprise several sub-steps in which the users request updates to the contract until it suits the requirement of both users.

The administrative processing system receives payment for the service from one or both users which is shared with the service provider. The payment can be paid in any stage of method 1000.

In some embodiments of the invention, administrative processing system may also manage the financial transaction between the users by performing stages 1050 to 1080. In a money obtaining stage, 1050, the administrative processing system obtains money or equivalent from the purchaser to the sum of the value of the transaction defined in the contract. In some cases, the administrative processing system acts as a trustee. In some cases the administrative processing system charges a commission to the purchaser. In a second checking stage 1060, the administrative processing system checks to see if the users require that the asset or object being bought/sold or transacted requires that a service center related to the administrative processing system should assist in the transfer of the asset or object from the seller to the purchaser. If negative, then the administrative processing system activates a confirmation checking stage 1065 to confirm that the asset or object has been transferred from the seller to the purchaser. If affirmative, the service center provides a transfer ownership service in a transfer asset stage 1070. In a transfer money stage 1080, the administrative processing system transfers the money received for the sale from the purchaser to the seller. The seller may be charged a commission for the sales transaction. Furthermore, both the purchaser and seller may be charged further for the service center services.

In embodiments of the invention, fewer, more and/or different stages than those shown in FIG. 10 may be executed. In embodiments of the invention one or more stages illustrated in FIG. 10 may be executed in a different order and/or one or more groups of stages may be executed simultaneously.

In one embodiment of the invention, an interactive interview, for example as discussed above with reference to FIG. 3, may be conducted with a user by providing a user with a series of graphical user interfaces. FIG. 11 through 31 illustrate graphical user interfaces provided to the browser of a user who is seeking a service including advice regarding college savings and therefore connects to the website “AdviceOverWeb”, according to an embodiment of the present invention. The service provider is termed in the advisor in the figures below because the service requested in this particular embodiment includes advice. The graphical user interfaces of FIGS. 11 through 31 do not necessarily present the complete sequence of graphical user interfaces presented to a user during an interview. The graphical user interfaces (GUIs) of FIGS. 11 through 31 are provided in order to illustrate certain features of some embodiments of the invention for a particular application (college savings advice), and therefore are not necessarily representative of all embodiments of the invention nor of all applications.

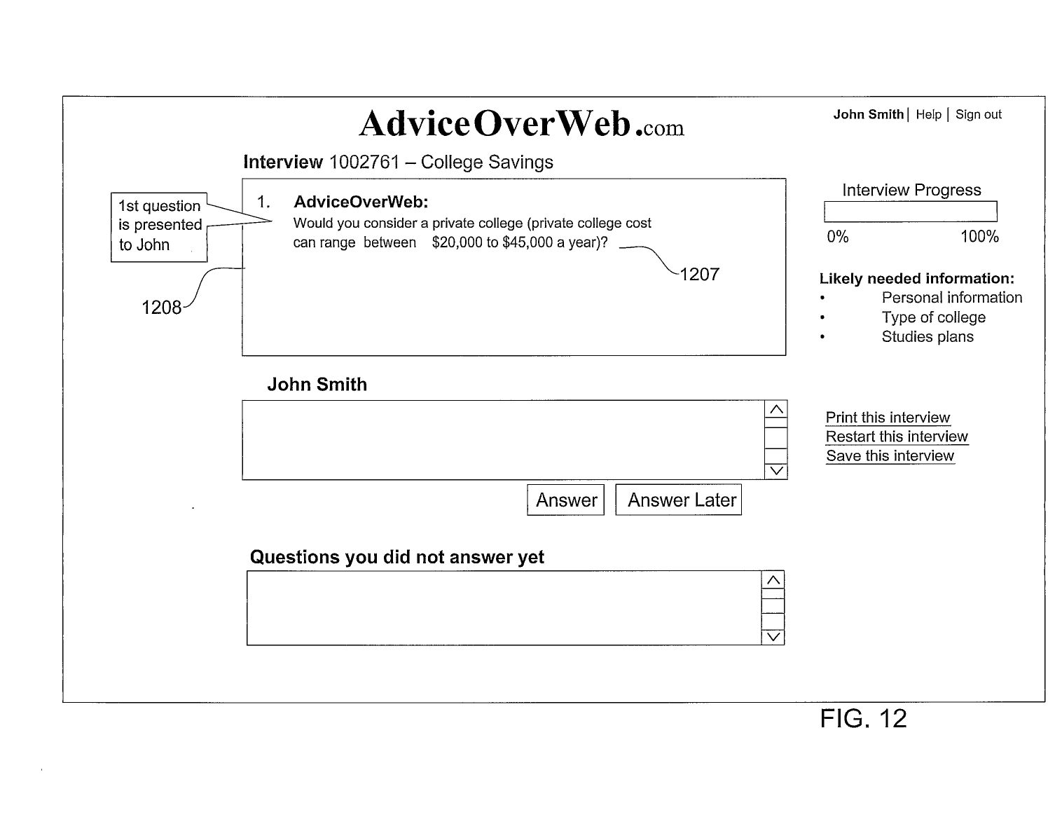

The GUI of FIG. 11 provides a user with introductory information 1102 explaining the process. The GUI of FIG. 11 also illustrates a log-in section 1104 for returning users and a sign-up link 1106 which a first-time user (or a returning user who does not want to log-in) can click to sign up for an interview. The GUI of FIG. 11 also provides a link 1103 for selecting an advisor, if one has not already been selected (for example the advisor may have referred the user to the website). After the user, in this case John Smith, has logged in as a returning user or signed up for an interview, the first question 1207 is presented to the user (“John”) in the question section 1208 (titled in this case “Interview 1002761-College Savings”) of the GUI of FIG. 12. In this embodiment, it is assumed that the topic of the interview, college savings advice, is known for example because the user has already selected the topic in a previous GUI, because the website is specific to college savings advice, based on which advisor directed the user to the website, based on an indication of the requested advice which may have been transferred from the advisor to the user and therefrom to the website, based on the selection by the user of an advisor (see link 1103 on FIG. 11) or for any other reason.

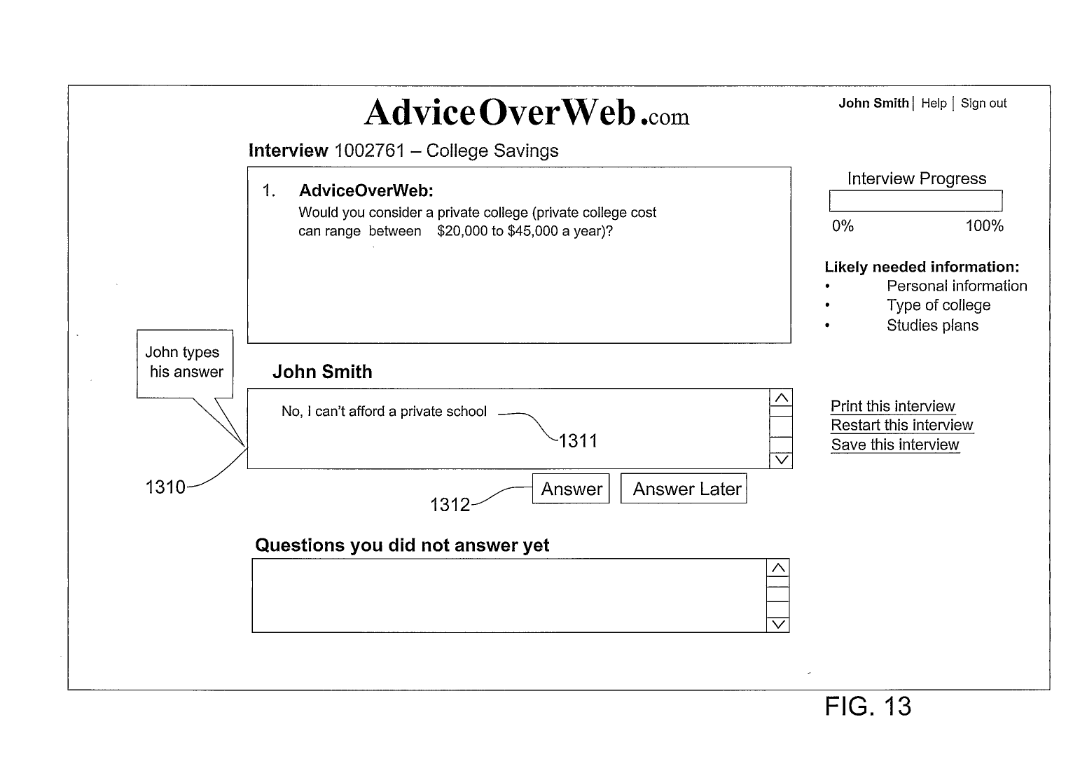

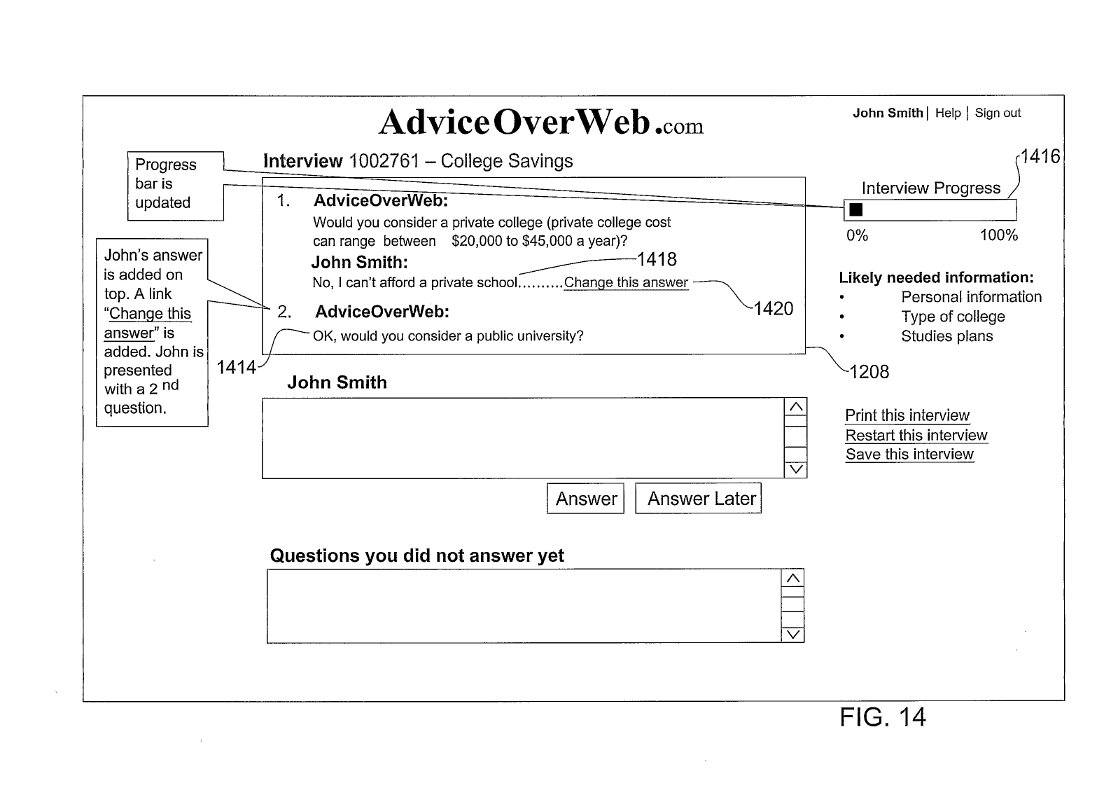

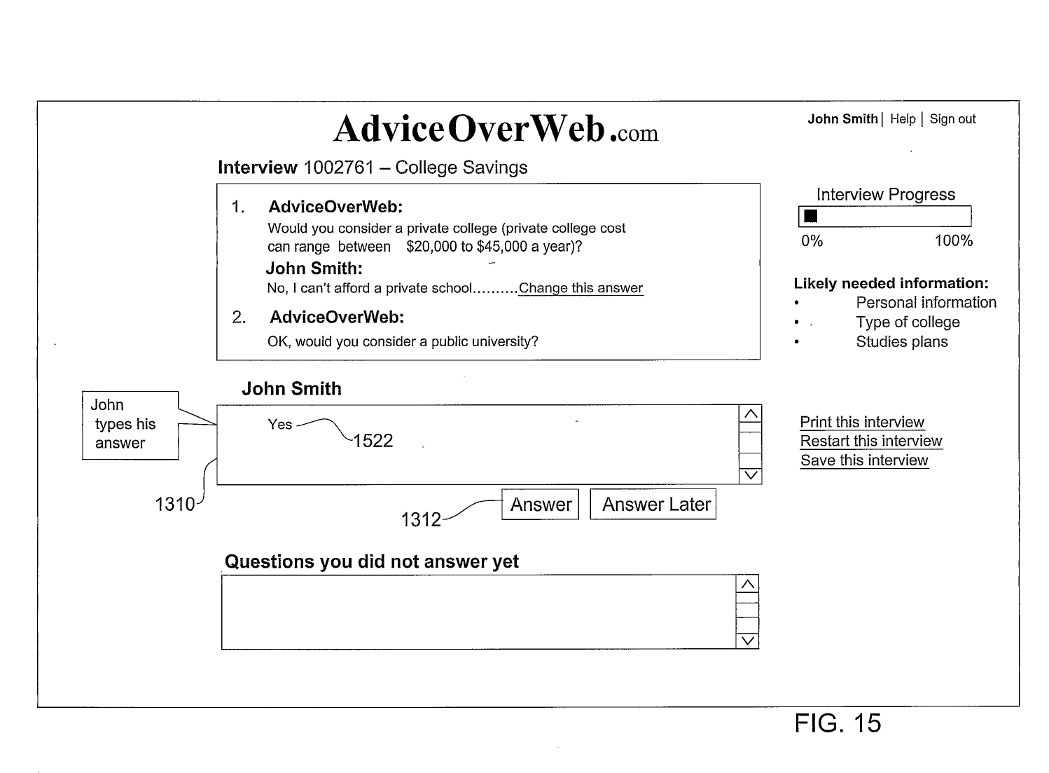

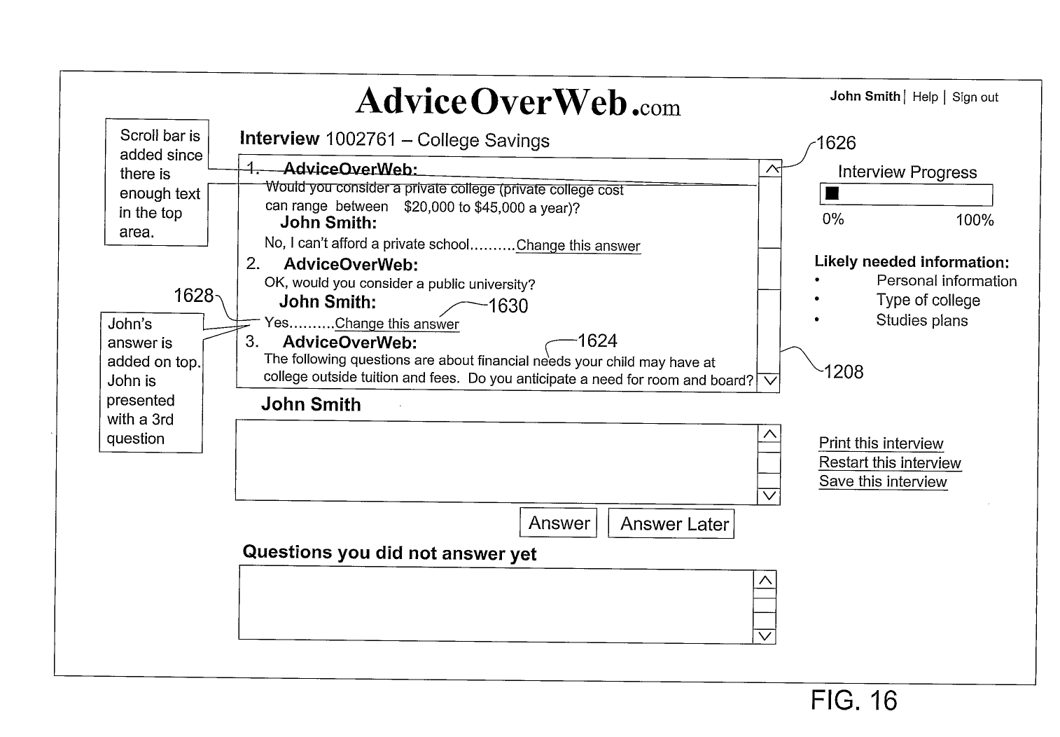

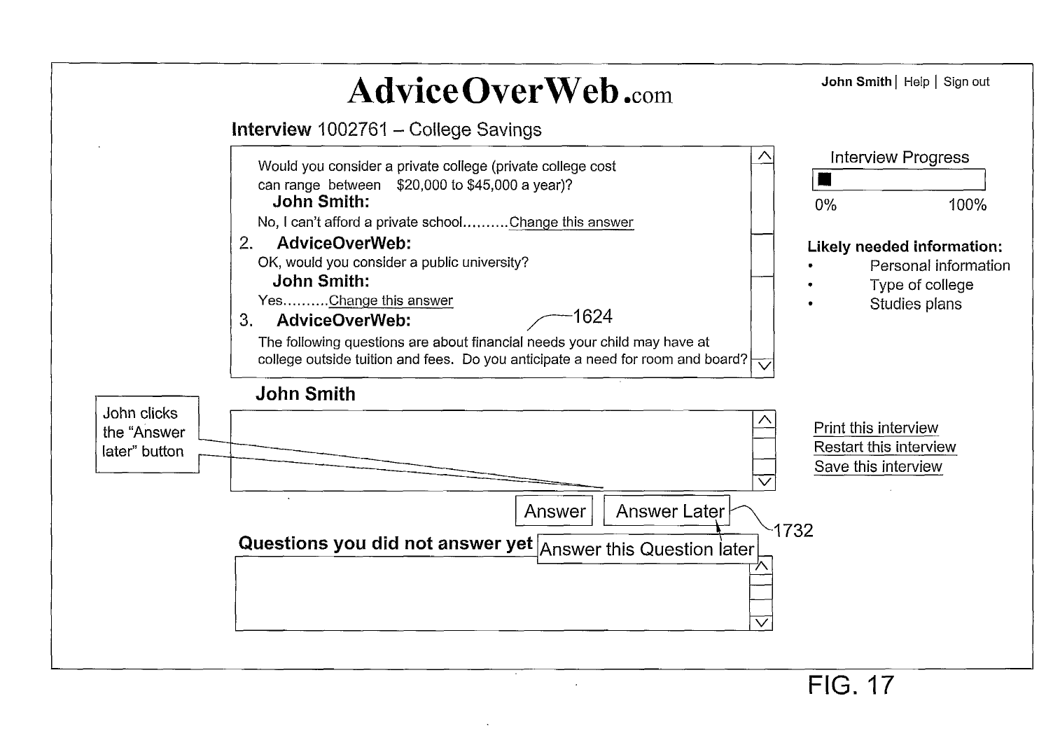

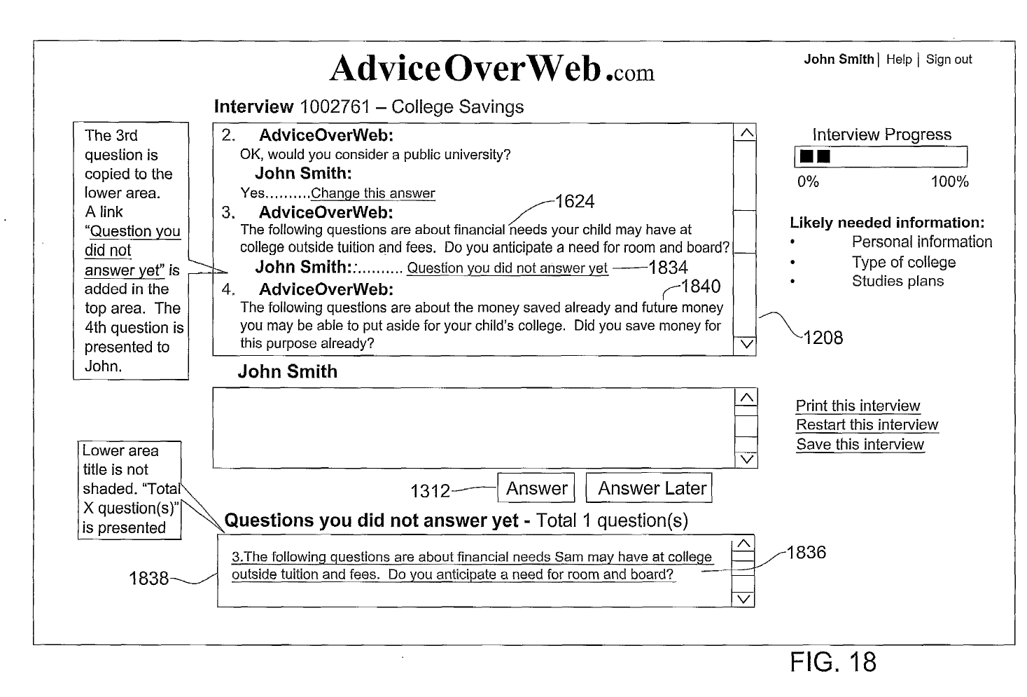

In the answer section 1310 (titled in this case “John Smith”) of the GUI of FIG. 13, the user types his answer 1311. After the user has clicked the answer button 1312, the GUI of FIG. 14 presents the user with a second question 1414 in question section 1208. The progress bar 1416 is also updated in FIG. 14. The user is also shown in question section 1208 his answer 1418 to the first question and is allowed to change his previous answer (using link 1420). In the GUI of FIG. 15, the user types his answer 1522 to the second question in answer section 1310. After the user has clicked answer button 1312, the GUI of FIG. 16 presents the user with a third question 1624 in question section 1208. Note that third question 1624 includes the reasoning for the question and possibly subsequent questions (i.e. “The following questions are about financial needs your child may have at college outside tuition and fees”). In addition, a scroll bar 1626 is added in FIG. 16 and the user's answer 1628 to the second question, which can be changed (using link 1630), is also displayed in question section 1208. In the GUI of FIG. 17, the user clicks the “answer later” button 1732 rather than answering third question 1624. The GUI of FIG. 18 points out that third question 1624 was unanswered both in question lo section 1208 (see link 1834) and by displaying a link 1836 to the unanswered question separately in a “Questions you did not answer yet” section 1838. It should be evident that either of these techniques may in some cases be applied separately. A fourth question 1840 is presented to the user in question section 1208. The reasoning for fourth question 1840 and possibly subsequent questions is provided (i.e. “The following questions are about the money saved already and future money you may be able to put aside for your child's college”).

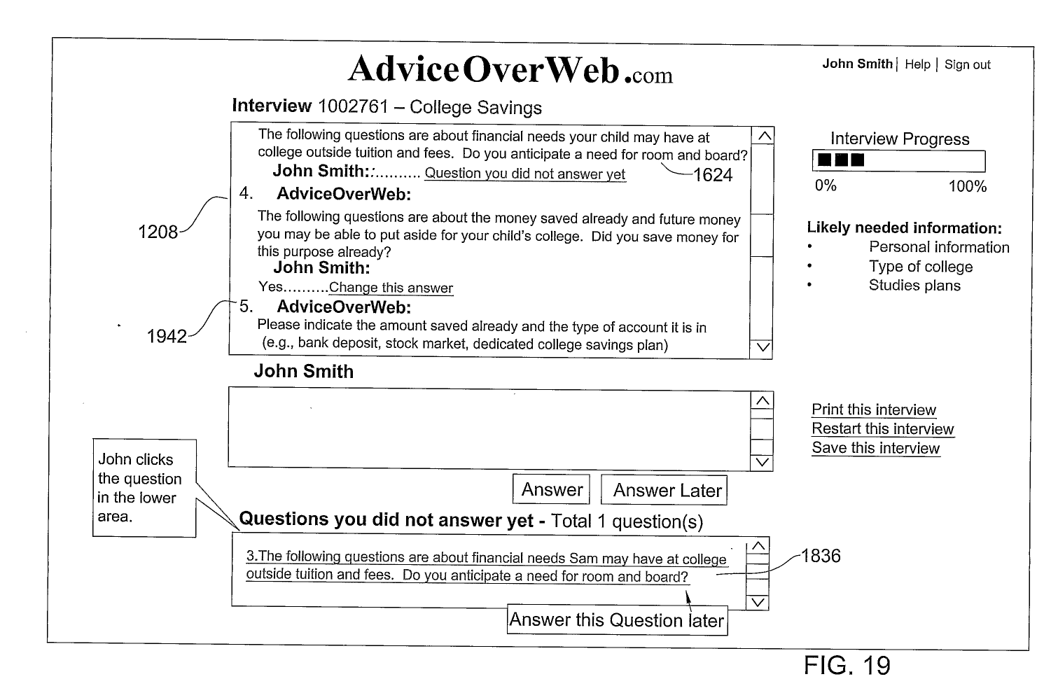

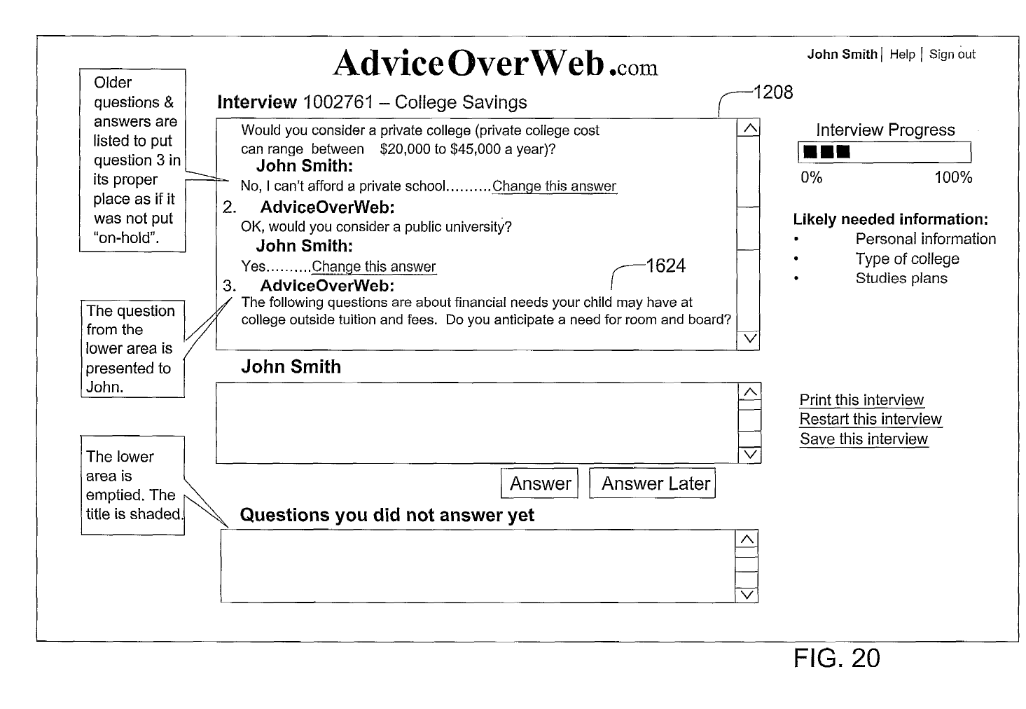

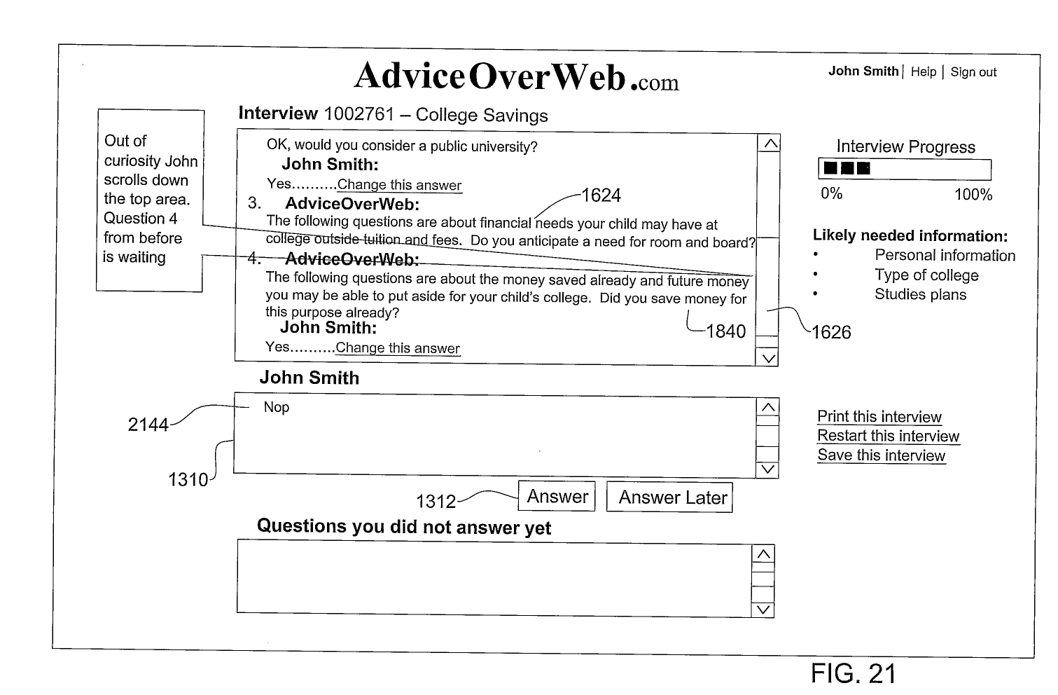

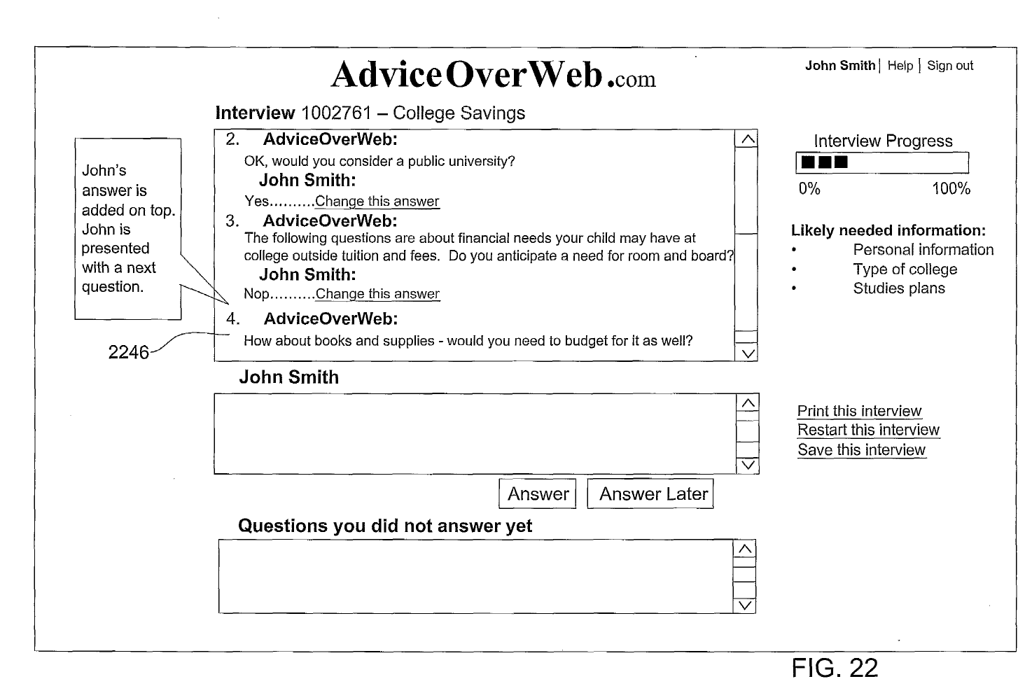

After the user has answered fourth question 1840 and pressed answer button 1312, a fifth question 1942 is presented to the user in question section 1208 of the GUI of FIG. 19. The user decides in FIG. 19 to click on link 1836 to the unanswered question so as to answer third question 1624 instead of the fifth question 1942. In the GUI of FIG. 20, third question 1624 is displayed in question section 1208 as if question 1624 had not been omitted (i.e. links 1834 and 1836 are not displayed in this GUI). In the GUI of FIG. 21, after the user has typed his answer 2144 to third question 1624 in answer section 1310, but prior to pressing answer button 1312, the user uses scroll bar 1626 to scroll down the GUI of FIG. 21 towards fourth question 1840. The user then scrolls back up to third question 1624 and presses answer button 1312. Based on the answer 2144 to third question 1624 (and/or due to third question 1624 having been answered), the user is presented in the GUI of FIG. 22 with a new fourth question 2246 (the original fourth and fifth questions 1840 and 1942 are renumbered fifth and sixth respectively).

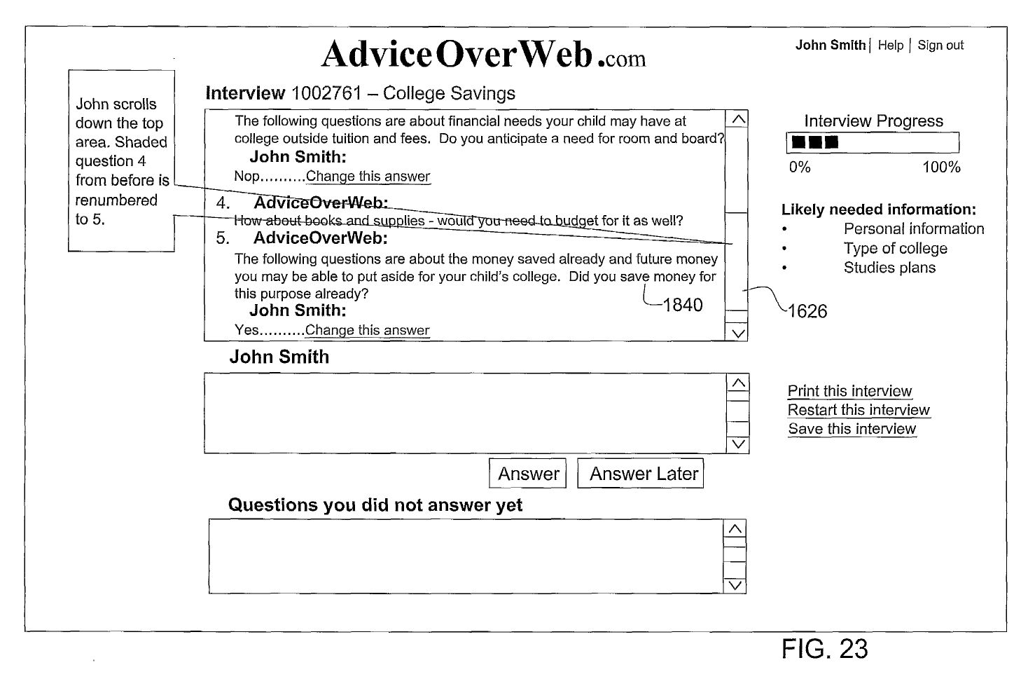

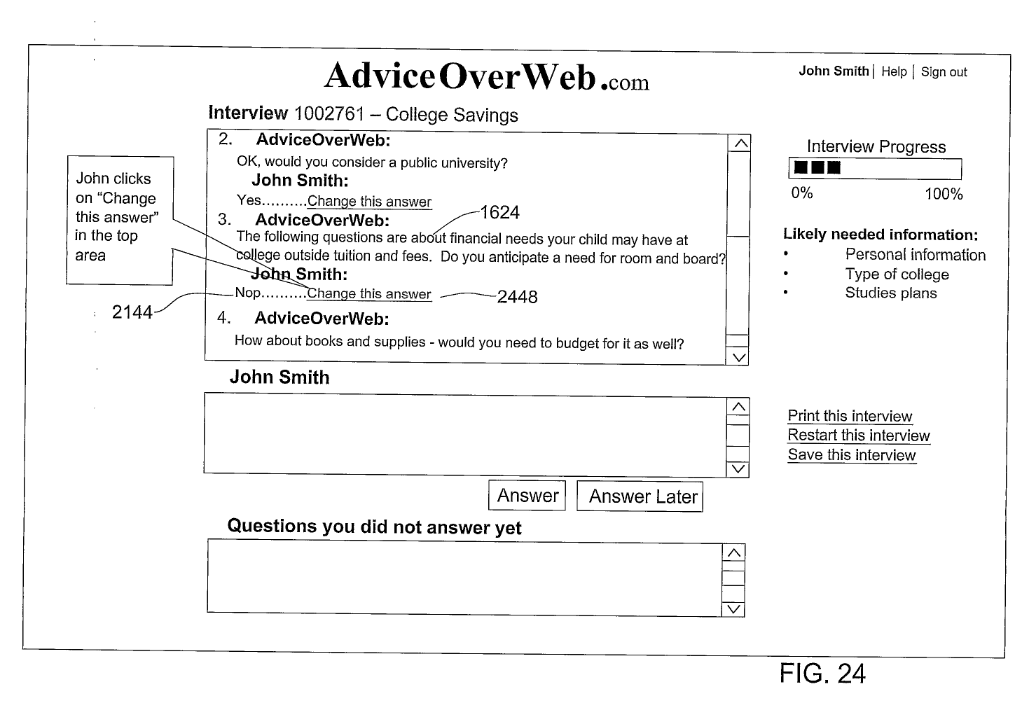

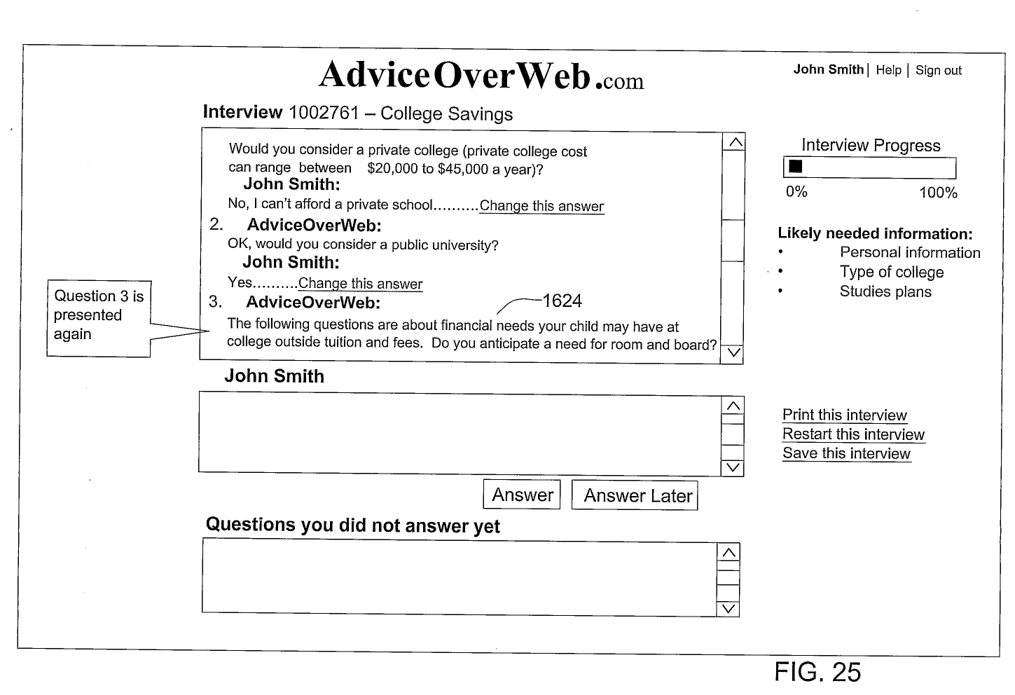

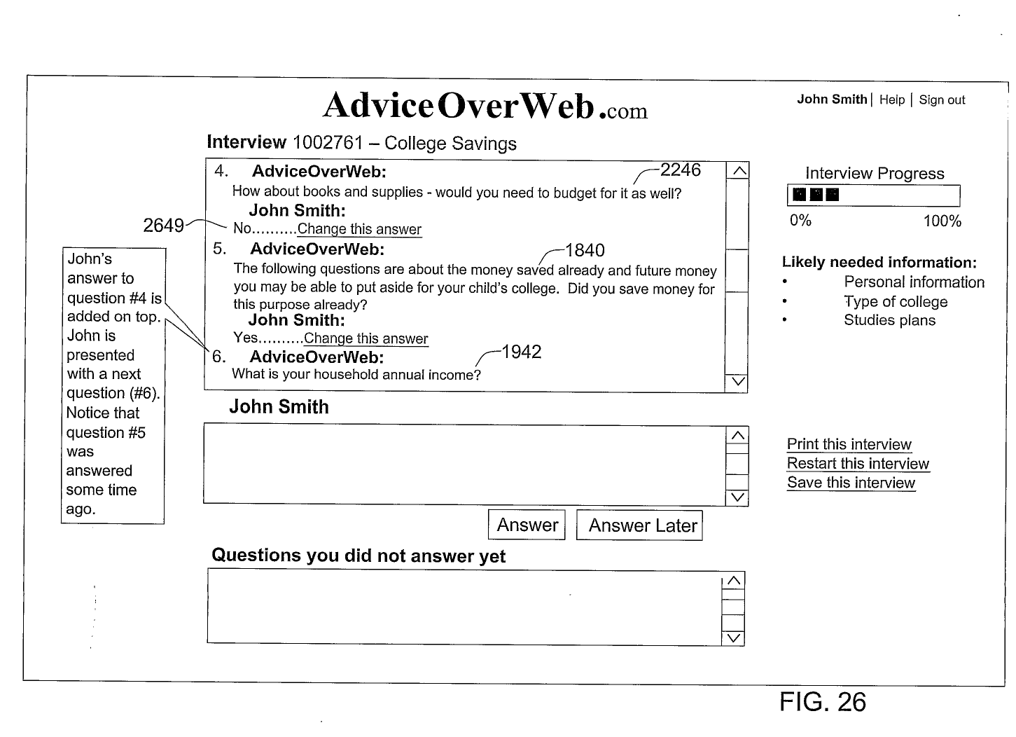

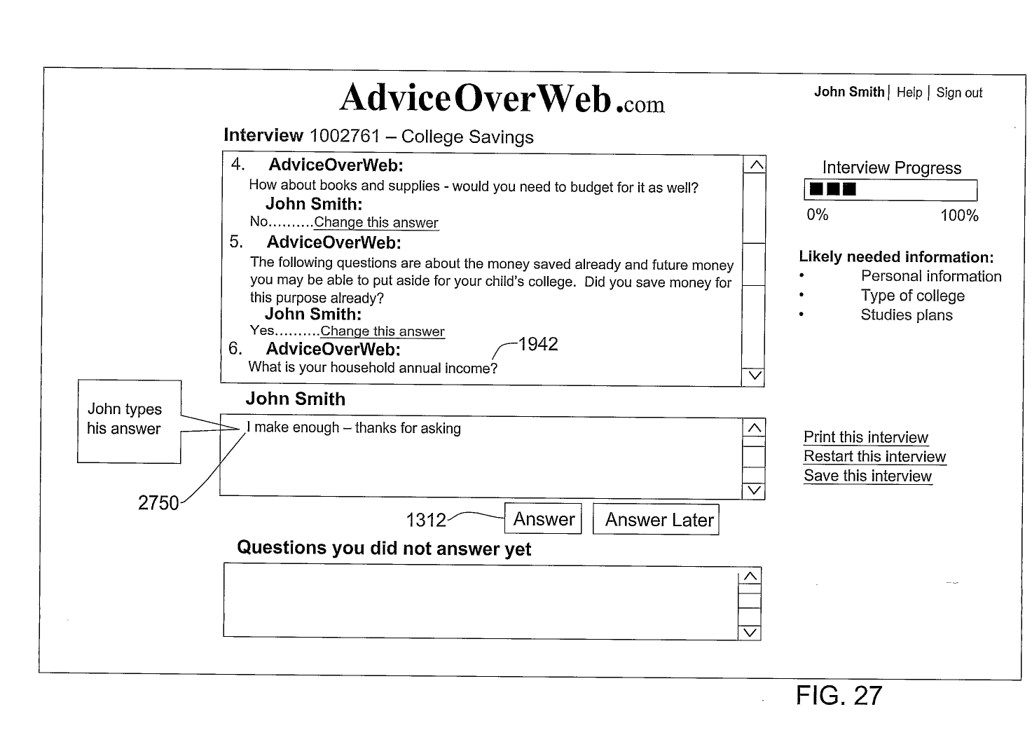

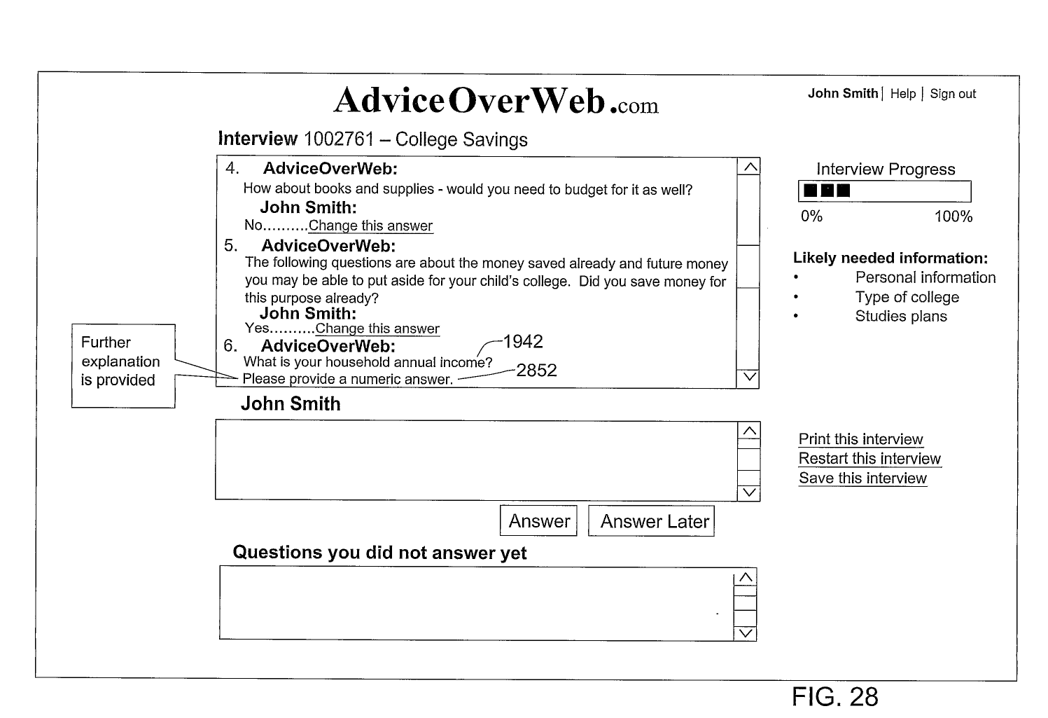

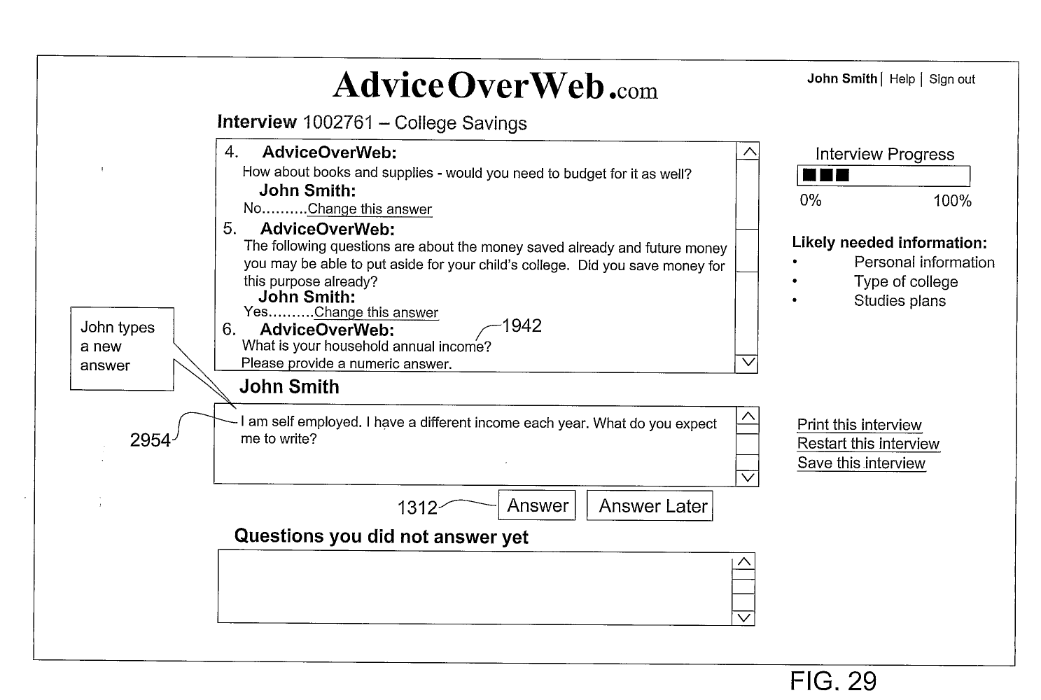

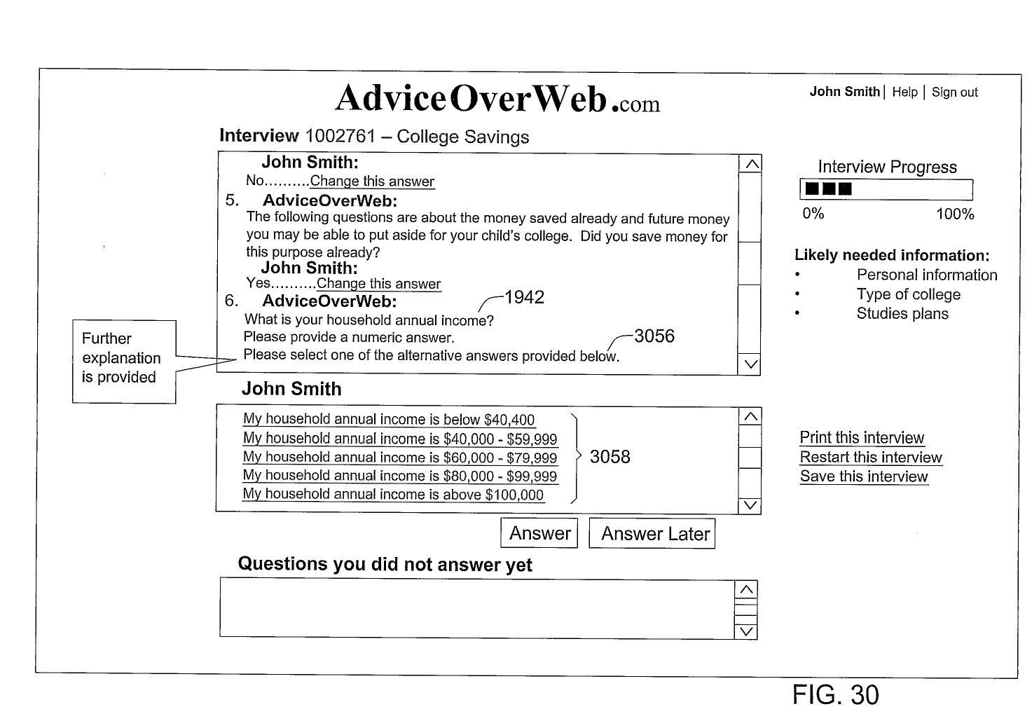

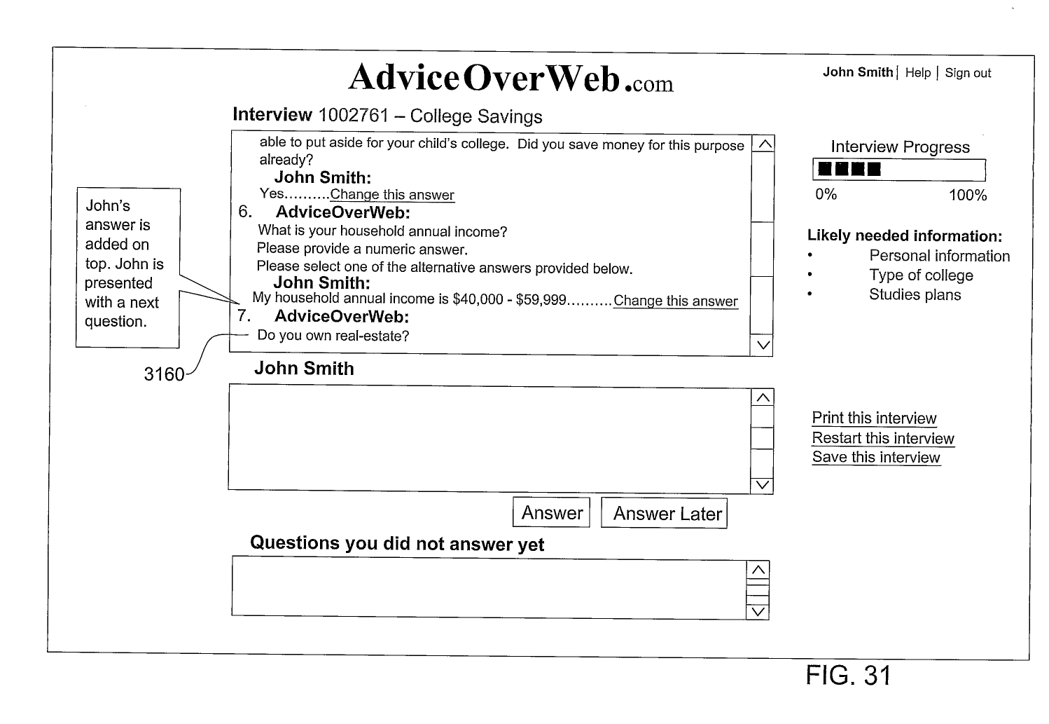

Prior to answering the new fourth question 2246, the user uses scroll bar 1626 to scroll down the GUI of FIG. 23 and sees that the original fourth question 1840 has been renumbered to #5. After the user has scrolled back up to third question 1624, the user clicks “change answer” link 2448 in the GUI of FIG. 24 to change answer 2144 to third question 1624. Therefore the GUI of FIG. 25 again presents the user with third question 1624. The user changes his answer to third question 1624 to “yes” and presses the answer button. The user then answers (new) fourth question 2246 (about books) as “no” (see 2649) and presses the answer button. Since fifth question 1840 (which was originally numbered 4) was already answered (see above), in the GUI of FIG. 26 the user is again presented with sixth question 1942 (which was originally question 5). The user provides an “inappropriate” answer 2750 to sixth question 1942 in the GUI of FIG. 27 and presses answer button 1312 and therefore in the GUI of FIG. 28, further explanation 2852 of question 1942 is provided to the user. The user again provides an “inappropriate” answer 2954 to sixth question 1942 in the GUI of FIG. 29 and presses answer button 1312, and therefore in the GUI of FIG. 30, further explanation 3056 of sixth question 1942 and multiple choice selection links 3058 are provided to the user. It is noted that sixth question 1942 is rephrased until the phrasing is acceptable to the user. After the user clicks on one of presented choices 3058, the next question 3160 is presented in the GUI of FIG. 31. The remainder of the interview is not presented here for the sake of brevity.

In some embodiments of the present invention, there may be any of the following advantages:

Assume embodiments where the administrative processing system processes users for a plurality of service providers. In some cases, the administrative processing of users even for different types of service providers includes gathering certain basic user information (for example name, email address, etc). Therefore in some of these cases it may be advantageous to share the resources for the processing of at least basic user information rather than replicating the resources for each service provider. In some cases, the processing of users for a certain type of service provider (for example insurance broker) may include asking many of the same questions. In some of these cases, sharing the resources for performing the administrative processing may therefore be even more advantageous.

Assuming embodiments where the administrative processing system processes users for more than one service provider, the processing system in some cases may be more likely to process the same user more often than would be an individual service provider. In some cases, the administrative processing system may store data previously provided by a user so that a user does not need to input the same data even if the user will be serviced by a different service provider. The user therefore may therefore in some cases advantageously find the administrative processing less burdensome.

In some cases, it may be clear to the user that the administrative processing system is independent of the service provider. Therefore, in some cases the user may be more likely to be willing to pay or pay more for the administrative processing. If the user is aware that the administrative processing system is a separate entity, the service provider in some cases is advantageously less likely to be viewed negatively by the user even if the user resents the payment.

In some cases, where the administrative processing system processes users for a plurality of service providers, the administrative processing system may be able to standardize the payments for administrative processing among service providers. If payments are standardized for example by basing charges on objective criteria and/or by charging an approximately uniform amount for similar services, the user in some cases may be more likely to accept the need for payment.

In some cases the user may prefer providing data not during one session. In some cases, the administrative processing system allows the user to provide data over more than one session, thereby advantageously encouraging a user to start providing data even if the provision will not be completed in one session. In some cases, the administrative processing system may provide reminders to the user to provide missing data, making it more likely that all missing data will be provided and quality service will advantageously result.

In some cases, the user may not be certain that the user wants the requested service. In some cases the administrative processing system allows the user to abort a requested service without charge, for example as long as a service provider has not been assigned to complete the requested service. The user may in some cases advantageously be more likely to request services since no financial obligation is required to be made at the onset of the interaction with the administrative processing system.

In some cases, the administrative processing system may monitor the service providers, advantageously resulting in some of these cases in quality service. For example, in some cases the administrative processing system may remind the service provider to complete services on time. As another example, in some cases the administrative processing system may compare the performance of different service providers.

In some cases, since the administrative processing system administratively processes the users, service providers may be advantageously able to focus more on providing services.

Assuming embodiments with an interactive interview, the user may be more likely to complete the interview in some cases if the interview has any of the following characteristics: interview questions are chat-like, questions are customized, the reasoning behind some or all of the questions is explained, questions can be answered out of order, questions can be reordered, questions can be posed in more than one session, interview progress is indicated, previously answered questions can be viewed, questions can be posed in more than one manner (i.e. rephrased), answers to previously answered questions can be changed and/or questions' contents may be based on previous answers.

Other advantages are apparent from the description herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The disclosures of all publications mentioned herein are incorporated herein by reference.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Although the invention has been described in conjunction with specific embodiments thereof, it is evident that many alternatives, modifications and variations will be apparent to those skilled in the art.

1.-56. (canceled)

57. A method of providing personalized advice to a user over a computer network, comprising:
(i) receiving a user-related input and defining a type of advice requested by the user;
(ii) automatically presenting the user with a plurality of questions relating to the service and preparing a personalized service profile based at least partly on answers of the user to said questions;
(iii) generating an advice output based at least partly on said personalized service profile, wherein said advice output includes information permitting the user to plan an activity; and
(iv) providing said advice output to the user.

58. The method of claim 57, further comprising generating a payment request and monitoring payment from the user.

59. The method of claim 57, wherein said receiving a user-related input comprises receiving information regarding the type of requested service from the user.

60. The method of claim 57, wherein said presenting includes:
presenting at least one of said plurality of questions during a first session with the user; and
presenting a remainder of said plurality of questions during at least one subsequent session with the user.

61. The method of claim 57, wherein said presenting includes: allowing the user to answer questions in a different order than presented.

62. The method of claim 57, wherein said presenting includes: inserting at least one additional question and renumbering any previously presented questions subsequent to said at least one inserted question.

63. The method of claim 57, wherein said presenting includes: presenting a question whose content is based on at least one answer to at least one previous question.

64. The method of claim 57, wherein said presenting includes: if the user does not provide an appropriate answer to a question, rephrasing said question and posing said rephrased question.

65. A method of providing personalized advice to a user over a computer network, comprising:
(i) a user logging on;
(ii) a system server identifying the type of advice requested by the user;
(iii) said system server posing service-related questions and receiving answers from the user;
(iv) said system server generating a personalized service profile based at least partly on said answers; and
(v) transferring an advice output to the user, wherein said advice output was generated based at least partly on said personalized service profile and includes information permitting the user to plan an activity.

66. The method of claim 65, further comprising generating a payment request sometime during the method and monitoring payment from the user.

67. The method of claim 65, wherein said posing service-related questions and receiving answers from the user includes:
presenting at least one of said questions during a first session with the user prior to the user disconnecting from said system server; and
presenting a remainder of said questions during at least one subsequent session with the user.

68. The method of claim 65, wherein said posing service-related questions and receiving answers from the user includes: allowing the user to answer questions in a different order than presented.

69. The method of claim 65, wherein said posing service-related questions and receiving answers from the user includes: inserting at least one additional question and renumbering any previously presented questions subsequent to said at least one inserted question.

70. The method of claim 65, wherein said posing service-related questions and receiving answers from the user includes: posing a question whose content is based on at least one answer to at least one previous question.

71. The method of claim 65, wherein said posing service-related questions and receiving answers from the user includes : if the user does not provide an appropriate answer to a question, rephrasing said question and posing said rephrased question.

72. A system for providing personalized advice to a user over a computer network, comprising:
a user communications manager configured to provide a plurality of questions to a web browser of a user who is interested in receiving advice; and
a job definer configured to prepare a personalized service profile based at least partly on answers of the user to said questions;
wherein an advice output which was generated based at least partly on said personalized service profile is transferred to the user by said user communications manager or directly by a service provider utility, and wherein said advice output includes information permitting the user to plan an activity.

73. The system of claim 72, wherein said user communications manager is configured to perform at least one task selected from a group comprising: pose questions over at least two sessions with the user, allow the user to answer questions in a different order than presented, insert at least one additional question and renumber any previously presented questions subsequent to said at least one inserted question, pose a question whose content is based on at least one answer to at least one previous question, and if the user does not provide an appropriate answer to a question, rephrase said question and pose said rephrased question.

74. A system for providing personalized advice to a user over a computer network, comprising:
a user communications manager configured to identify the type of advice requested by a user, and configured to pose service-related questions to the user; and
a job definer configured to generate a personalized service profile based at least partly on answers of the user to said questions;
wherein an advice output based at least partly on said personalized service profile is transferred to the user by said user communications manager or directly by a service provider utility, and wherein said advice output includes information permitting the user to plan an activity.

75. The system of claim 74, wherein said payment processor is configured to generate a payment request for the user and monitor payment from the user.

76. The system of claim 74, wherein said user communications manager is configured to identify the type of advice requested by a user who has logged on a website of a service provider and been routed to said user communications manager.

77. The method of claim 57, further comprising: electronically forwarding said personalized service profile to a service provider utility, wherein said service provider utility generates said advice output.

78. The method of claim 57, wherein said requested advice is selected from a group comprising: mortgage advice, investment advice, savings advice, personal advice, and medical advice.

79. The method of claim 57, wherein at least one of said answers relates to a user attribute or a user preference.

80. The method of claim 66, wherein if the user has paid, the method further comprising transmitting said personalized service profile to a service provider utility, wherein said service provider utility generates said advice output and wherein said advice output is transferred to the user by said system server or directly by said service provider utility.
